(19) United States
(12) Patent Application Publication
(10) Pub. No.: US 2025/0039872 A1
(43) Pub. Date: Jan. 30, 2025

(54) METHOD FOR PROVISIONING AD HOC MONITORING TIME FOR REPITITION GRANTS AND USER EQUIPMENT ENERGY SAVINGS

(71) Applicant: Nokia Technologies Oy, Espoo (FI)

(72) Inventors: John HARRIS, Whitefish Bay, WI (US); Stefano PARIS, Massy (FR); Nhat-Quang NHAN, Massy (FR); Daniela LASELVA, Aalborg (DK)

(21) Appl. No.: 18/784,858

(22) Filed: Jul. 25, 2024

Related U.S. Application Data
(60) Provisional application No. 63/515,972, filed on Jul. 27, 2023.

(51) Int. Cl. H04W 72/1268; H04W 72/0446; H04W 72/566

(52) U.S. Cl. CPC H04W 72/1268; H04W 72/0446; H04W 72/566

(57) ABSTRACT

A method, apparatus, and computer program product are provided. In the context of a method, the method includes identifying a scheduled transmission interval having a beginning time and an end time, based on initial scheduling information received from a network node, where the scheduled transmission interval is longer than a threshold duration for an uplink transmission by the user equipment according to initial scheduling information, where the scheduled transmission interval includes a head end portion and a tail end portion, and the tail end portion accommodates a monitoring period. The method includes transmitting respectively, to a network node, an uplink transmission corresponding to a respective subsequent scheduled transmission interval, according to subsequent scheduling information received from the network node, within the monitoring period before the end time.

### TECHNOLOGICAL FIELD

An example embodiment relates generally to provisioning user equipment ad hoc monitoring time (or tail active time duration) for repetition or series of granted transmission or reception allocations to save user equipment energy.

### BACKGROUND

A user equipment often is configured with grants well prior to transmission. Oftentimes, this may result in inefficiency, as early granting of allocations may not be appropriately sized and prioritized. For example, video traffic generated by extended reality services has in uplink has periodic burst arrivals with variable burst size. It is difficult to determine in advance what the right size of extended reality data will be, which may result in waste of radio resources (due to over-dimensioning of granted resources for repetitions) or unable to fulfil a delay budget (due to under-dimensioning of granted resources for repetitions). Currently, a discontinuous reception inactivity timer is started at the time of reception of a new physical downlink shared channel grant so that further data may be scheduled next. There is a need for a method of providing grants closer to a time of transmission compared with previous methods.

### BRIEF SUMMARY

In one or more embodiments, a user equipment (120) is provided, including at least one processor and at least one memory storing instructions that, when executed by the processor, cause the user equipment (120) to identify (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the user equipment (120) is further caused to transmit respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, a network node (140) is provided, including at least one processor at least one memory storing instructions that, when executed by the processor, cause the network node (140) to configure (1910), a user equipment (120), with parameters and indicators (1500) that instructs the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the network node (140) is further caused to receive respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

In one or more embodiments, a computer-implemented method is provided that is performed by a user equipment (120) and includes identifying (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). The computer-implemented method further includes transmitting respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, a computer-implemented method is provided that is performed by a network node (140) and includes configuring (1910), a user equipment (120), with parameters and indicators (1500) that instructs the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the computer-implemented method further includes receiving respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

In one or more embodiments, a non-transitory computer readable storage medium is provided including computer instructions that, when executed by a user equipment (120), cause the user equipment (120) to identify (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the user equipment (120) is further caused to transmit respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, a non-transitory computer readable storage medium is provided including computer instructions that, when executed by a network node (140), cause the network node (140) to configure (1910), a user equipment (120), with parameters and indicators (1500) that instructs the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the network node (140) is further caused to receive respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

In one or more embodiments, a user equipment (120) is provided including means for identifying (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the user equipment (120) further includes means for transmitting respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, a network node (140) is provided that includes means for configuring (1910), a user equipment (120), with parameters and indicators (1500) that instructs the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the network node (140) further includes means for receiving respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a system including both a base station and user equipment configured to communicate via at least uplink and downlink transmission in accordance with an example embodiment of the present disclosure.

FIG. 2 is a block diagram of an example communication system in which the system of FIG. 1 may be deployed in accordance with an example embodiment of the present disclosure.

FIG. 3A illustrates an identified problem by the disclosure, during a first scheduled transmission interval.

FIG. 4 illustrates an identified scheduling problem by the disclosure, when repetitions take place during a first transmission interval, which are to be solved by the disclosure.

FIG. 5 illustrates an identified problem by the disclosure, when a first scheduled transmission interval includes repetitions.

FIG. 6 illustrates an identified problem by the disclosure regarding a retransmission scenario after repetitions.

FIG. 7 illustrates an identified problem by the disclosure, when scheduling a first transmission interval may be caused by configured grants.

FIG. 8 illustrates an identified problem by the disclosure regarding cell discontinuous transmission scenario.

FIGS. 9A-9E illustrate an identified problem by the disclosure, regarding physical uplink shared channel (PUSCH) allocation.

FIG. 10 illustrates an example solution to a problem created by a first scheduled transmission interval in accordance with an example embodiment of the present disclosure.

FIG. 11 illustrates an example solution to a problem created by a first scheduled transmission interval including repetitions in accordance with an example embodiment of the present disclosure.

FIG. 12 illustrates an example solution to a problem in a retransmission scenario in accordance with an example embodiment of the present disclosure.

FIG. 13 illustrates an example scenario where monitoring time may be accommodated in accordance with an example embodiment of the present disclosure.

FIG. 14A-14B illustrate example retransmission scenarios where monitoring time may be accommodated in accordance with an example embodiment of the present disclosure.

FIG. 15 illustrates an example solution when a first scheduled transmission interval may be caused by configured grants in accordance with an example embodiment of the present disclosure.

FIG. 16 illustrates an example solution in a cell discontinuous reception scenario in accordance with an example embodiment of the present disclosure.

FIG. 17 is an illustration adding detail to the solution of FIG. 12 in accordance with an example embodiment of the present disclosure.

FIG. 18 illustrates a solution to a problem with physical uplink shared channel allocation in accordance with an example embodiment of the present disclosure.

FIG. 19 is a flowchart illustrating functionality of a user equipment and/or a network node in accordance with an example embodiment of the present disclosure.

FIG. 20 is a signaling diagram between a user equipment and a network node in accordance with an example embodiment of the present disclosure.

FIG. 21 is a flowchart demonstrating the operations performed, such as by a UE 120 in accordance with an example embodiment of the present disclosure.

FIG. 22 is a flowchart illustrating the operations performed by a NW node 140 in accordance with an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments may be embodied in many different forms and not to be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms not to be taken to limit the spirit and scope of embodiments of the present disclosure.

Additionally, as used herein, the term “circuitry” refers to (a) hardware-only circuit implementations (e.g., implementations in analog circuitry and/or digital circuitry); (b) combinations of circuits and computer program product(s) including software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation including one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encored thereon computer-executable instructions or software programs. A non-transitory “computer readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more universal synchronous bus (USB) flash drives), computer system memory or random-access memory (such as dynamic random access memory (DRAM), static random access memory (SRAM), extended data out random access memory (EDO RAM), and the like.

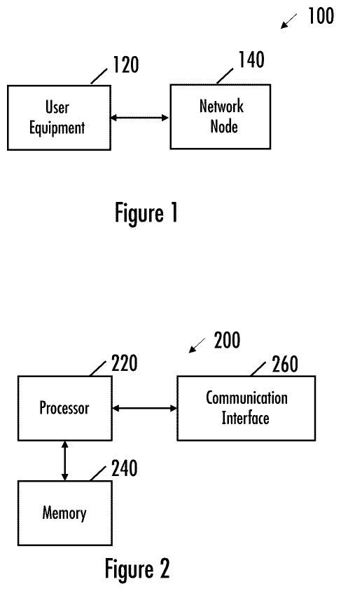

As illustrated in FIG. 1, a system 100 is provided in accordance with an example embodiment in order to facilitate uplink transmission from user equipment 120. Although the system may be configured in various manners, the system of one embodiment is depicted in FIG. 1 and includes both user equipment 120 and network node 140 configured to communicate via uplink and downlink transmission and reception beams. Although one user equipment and one network node are depicted, the system may include and the user equipment 120 and/or network node 140 may communicate with additional user equipment and network nodes in other embodiments. In one or more embodiments, the user equipment 120 and network node 140 may configured to support, for example, 4G, 5G advanced, or 6G. In one or more embodiments, the system 100 may support carrier aggregation and/or dual connectivity. As described below, the system is configured to transmit messages and reports, such as reconfiguration messages, radio resource control messages, MAC control element messages, downlink control information messages, physical uplink shared channel messages, physical downlink control channel messages, and/or the like.

The data that is transmitted via the uplink and downlink beams between the user equipment 120 and the network node 140 may be any of a wide variety of data including, but not limited to digital imagery data including video data, audio data as well as data provided by sensors, radars, telescopes and radio receivers. In at least some instances, the data is encoded prior to communication of the data via the uplink and downlink beams and decoded upon reception. The resulting data received may be utilized for a variety of purposes including presentation to a user, storage of the data for subsequent use and/or provision of the data to one or more applications, such as applications that perform statistical inference on the data for various purposes including object recognition, image classification, spectrum sensing, speech transcription and/or prediction or detection of events.

The user equipment 120 of FIG. 1 (also called UE, user device, user terminal, terminal device, etc.) illustrated one type of an apparatus which resources on an air interface are allocated and assigned. The user equipment 120 typically refers to a portable computing device that includes wireless mobile communication devices operating with or without a subscriber identification module (SIM), including, but not limited to, the following types of devices: a mobile station (mobile phone), smartphone, personal digital assistance (PDA), handset, device using a wireless modem (alarm or measurement device, etc.), laptop and/or touch screen computer, tablet, game console, notebook, and multimedia device. User equipment 120 may also be a device having capability to operate in Internet of Things (IoT) network which is a scenario in which objects are provided with the ability to transfer data over a network without requiring human-to-human or human-to-computer interaction. The user equipment 120 (or in some embodiments a layer 3 relay node) is configured to perform one or more of user equipment functionalities. The user equipment 120 may also be called a subscriber unit, mobile station, remote terminal, access terminal, user terminal, or user equipment (UE) just to mention but a few names or apparatuses.

The network node 140 of FIG. 1 may include, for example, remote radio heads (RRHs), transmission reception points (TRPs), access points, node Base stations (e.g., eNB, gNB) or other transmission sources. The network node 140 may be configured to communicate with user equipment 120 via a network.

FIG. 2 depicts an example apparatus 200 that may be configured to function as user equipment 120 or network node 140. As shown in FIG. 2, the apparatus includes, may be associated with, or may be in communications with processing circuitry 220, a memory 240, and a communication interface 260. The processing circuitry 220 may be in communication with the memory device 240 via a bus for passing information among components of the apparatus. The memory device may be non-transitory and may include, for example, one or more volatile and/or non-volatile memories. In other words, for example, the memory device may be an electronic storage device (e.g., a computer readable storage medium) including gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 200 may, in some embodiments, be embodied in various computing devices described as above. However, in some embodiments, the apparatus may be embodied as a chip or chip set. In other words, the apparatus may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chipset may constitute means for performing one or more operations for providing the functionalities described herein.

The processing circuitry 220, also referenced as a processor, may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining, and/or multithreading.

In an example embodiment, the processing circuitry 220 may be configured to execute instructions stored in the memory device 240 or otherwise accessible to the processing circuitry. Alternatively or additionally, the processing circuitry may be configured to execute hardcoded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry may be embodied as an ASIC, FPGA or the like, the processing circuitry may be specifically configured hardware for conducting the operations described herein. Alternatively, as another example, when the processing circuitry may be embodied as an executor of instructions, the instructions may specifically configure the processor to perform the algorithms and/or operations described herein when the instructions are executed. However, in some cases, the processing circuitry may be a processor of a specific device (e.g., an image or video processing system) configured to employ an embodiment by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 260 may be any means such as a device or circuitry embodied in either hardware or a combination of hardware and software that is configured to receive and/or transmit data including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communications interface may alternatively or also support wired communication. As such, for example, the communication interface may include a communication modem and/or other hardware/software for supporting communication via cable, digital subscriber line (DSL), universal serial bus (USB) or other mechanisms.

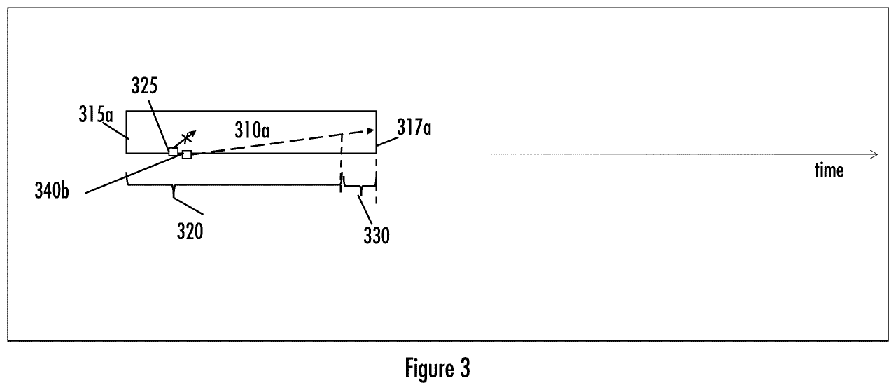

Turning now to FIG. 3, illustrates an identified problem by the disclosure, during a first scheduled transmission interval. In one or more embodiments, block 310 illustrates a first scheduled transmission interval 310a. The first scheduled transmission interval 310a may be a transmission interval that has already been indicated/signaled to the UE (scheduled) but where the UE has not yet finished performing the transmission during that first scheduled transmission interval 310a. A user equipment 120 may be blocked from scheduling new transmissions during the first scheduled transmission interval 310a. The first scheduled transmission interval 310a has a start time 315a and an end time 317a. The first scheduled transmission interval 310a may have a long anticipatively-granted interval (LAGI). During the long anticipatively-granted interval (LAGI), a user equipment (UE) 120 may be blocked from new uplink or downlink transmissions due to already scheduled transmissions. In an example, a first scheduled transmission interval 310a may include, performing physical uplink shared channel repetitions of a hybrid automatic repeat request (HARQ) process. In another example, the UE 120 may be blocked from performing new PUSCH transmissions (420b to 420n) during Time Division Duplex (TDD) slots which are allocated for downlink (DL) transmission.

A user equipment 120 may monitor for scheduling transmission information (e.g., uplink or downlink information) (340a) during downlink control channel monitoring occasion, which a user equipment 120 may receive downlink control information (DCI) 340a on physical downlink control channel (PDCCH)) in order to schedule future user equipment transmission.

In one or more embodiments, the UE may be blocked from performing new PUSCH transmissions (e.g., 420b to 420n) after receiving the first scheduling information (e.g., downlink control information) 340a during a head end portion 320 of the first scheduled transmission interval 310a, thus lowering transmission efficiency. Therefore, uplink or downlink (UL/DL) scheduling, may be required to occur far in advance when first transmission scheduling information (i.e., downlink control information) 340a is received during the head end portion 320 of first scheduled transmission interval 310a. According to an embodiment of the disclosure, it may be more efficient for monitoring time to instead, be scheduled during a tail end portion 330 of first scheduled transmission interval 310a. This monitoring at the tail end portion 330 may allow just in time scheduling and also allow sufficient time to utilize fresh information to determine when to schedule transmission of the subsequent physical uplink shared channel (e.g., 420b to 420n).

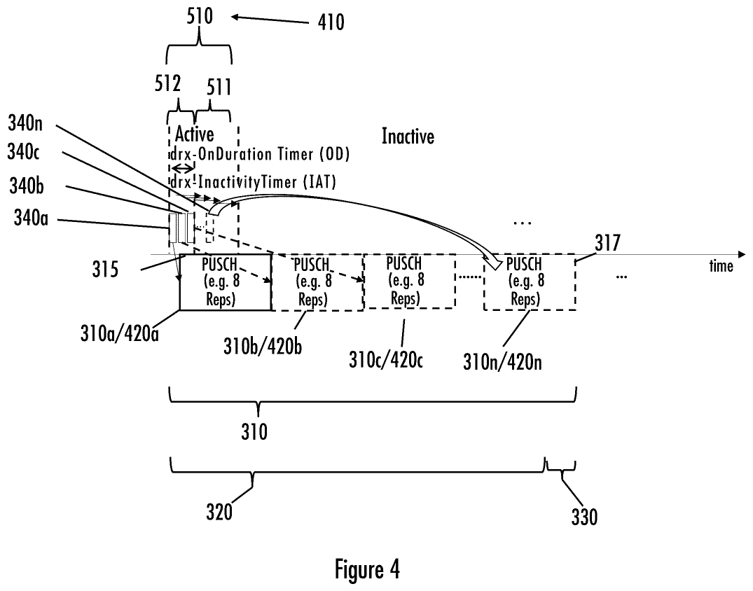

FIG. 4 illustrates an identified scheduling problem when repetitions take place during a first transmission interval. Initially, during physical downlink control channel monitoring occasions 410/510 (i.e., in a head end portion 320 of the first scheduled transmission interval 310) a user equipment 120 may be scheduled to transmit repetition bundles during 420a to 420n after receiving uplink scheduling grants from a network node 140. A discontinuous reception inactivity timer (IAT) may start at the time of a physical downlink control channel grant. During the discontinuous reception inactivity timer (IAT), the user equipment 120 may monitor for transmission scheduling information. The subsequent (e.g. nth) repetition bundles 420a to 420n may be scheduled far in advance. For example a first repetition bundle 420 may be scheduled at, for example, K2=2. The user equipment 120 may need to transmit multiple uplink hybrid automatic repeat request (HARQ) processes (e.g., due to multiple packets or packet fragmentation). Future repetition bundles 420 (such as PUSCH 420b to 420n) may be scheduled at, for example, K2=2+N*(8−1+12). However, as the number of repetition bundles 420 increase, they (such as PUSCH 420b to 420n) must be scheduled further out. Therefore, each physical uplink scheduling grant may schedule repetition bundles 420 for transmission on physical uplink shared channel (420b to 420n), which may block other new transmissions. In this case, the first scheduled transmission interval 310a may last until the last repetition bundle 420 is over. In this case, any downlink control monitoring occasion 410 scheduling PUSCH during the head end portion 320 of first scheduled transmission interval 310 may be inefficient due to a need of having to schedule far in advance. The disclosure therefore suggests that it may be more efficient to perform just in time monitoring and scheduling during the tail end portion 330 (instead of during the head end portion 320) of the first scheduled transmission interval 310.

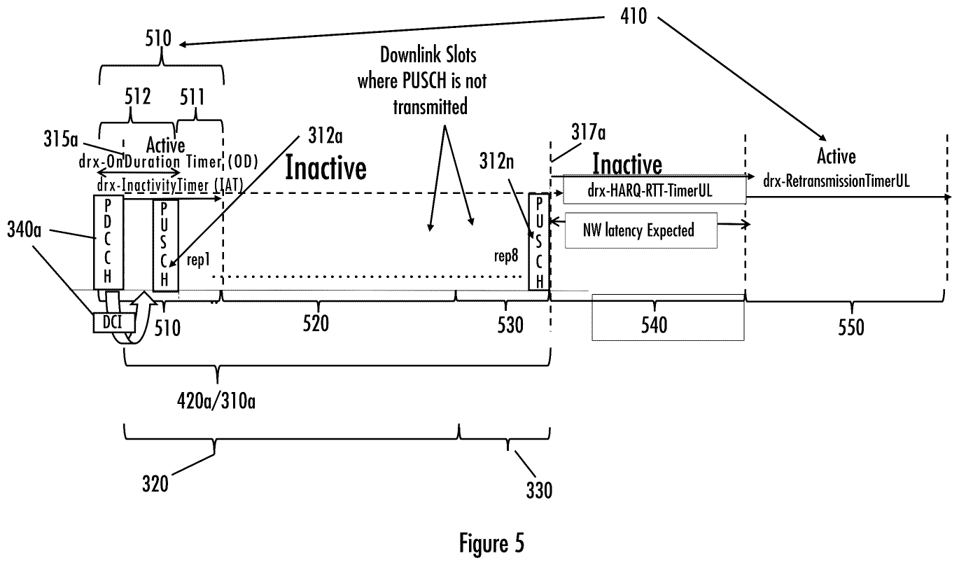

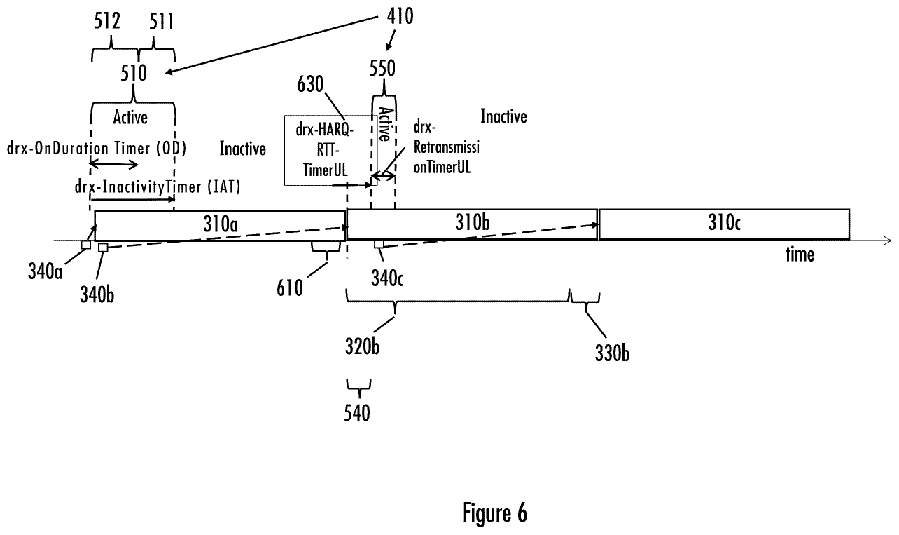

Turning now to FIG. 5, which illustrates a problem found when the first scheduled transmission interval may be caused by a grant scheduling repetitions. For example, when the user equipment 120 may be in monitoring period 510 until the end of the discontinuous reception inactivity timer. However, it may be inefficient to schedule this far in advance due to the bundle of repetition 420 that is scheduled for the rest of the first scheduled transmission time 310. Additional monitoring time may not be scheduled during time periods 520 and 530. Monitoring time may be inefficient during time period 520 since it occurs during the head end portion 320 of the first scheduled transmission interval 310. The present disclosure suggests that monitoring time (for additional PUSCH grants) may be (relatively) efficiently scheduled during time period 530 since this occurs towards the tail end portion 330 of first scheduled transmission period 310a. During time period 540 (in the head end portion 320 of 310b in FIG. 6), monitoring time may not be scheduled as retransmission processing. Monitoring time may then occur during time period 550 when a retransmission of the first scheduled transmission interval 310a may be expected. For physical downlink shared channel scenarios, retransmission may only be expected if a negative acknowledgment was sent by the user equipment 120.

Turning now to FIG. 6, which illustrates an identified problem by the disclosure regarding a retransmission scenario after repetitions (for example, the PUSCH). In an example, a user equipment 120 may receive first scheduling information 340a via downlink control information (DCI), and then transmit physical uplink shared channel (PUSCH) repetitions during the first scheduled transmission interval 310a. The user equipment 120 may also monitor for a new or subsequent scheduling information 340b during monitoring periods 510 and 511 until the inactivity timer expires. However, it may not be efficient for the user equipment to monitor for the subsequent scheduling information 340b (for subsequent PUSCH grants 420b to 420n) during the monitoring period 510. Instead, it may be more efficient for the user equipment to monitor the subsequent scheduling information 340b at a monitoring period 610 during the tail end portion 330 of the first scheduled transmission interval 310a, so that the subsequent scheduling information 340b may be up to date.

After the conclusion of the first scheduled transmission interval 310a, a discontinuous reception retransmission timer 630 (RTT timer) may start to run in a subsequent or subsequent scheduled transmission interval 310b. At the expiration of the discontinuous reception retransmission timer 630, a subsequent monitoring period 550 may occur where the user equipment may monitor for a subsequent received scheduling information 340b, such as the subsequent downlink control information (DCI) 340a′ indicating that a retransmission should be performed for the unfinished scheduled transmission in the first scheduled transmission interval 310a. However, this may not be efficient here because the user equipment 120 may already be transmitting physical uplink shared channel (PUSCH) repetitions for a different hybrid automatic repeat request (HARQ) process in a subsequent scheduled transmission interval 310b. The monitoring period 550 is at the head end portion 320 of the subsequent scheduled transmission interval 310b, and the user equipment 120 must therefore, wait until the conclusion of the subsequent scheduled transmission interval 310b to complete performing the retransmission. The present disclosure therefore suggests instead that it may be more efficient for monitoring time to take place during the tail end portion 330 of the subsequent scheduled transmission interval 310b.

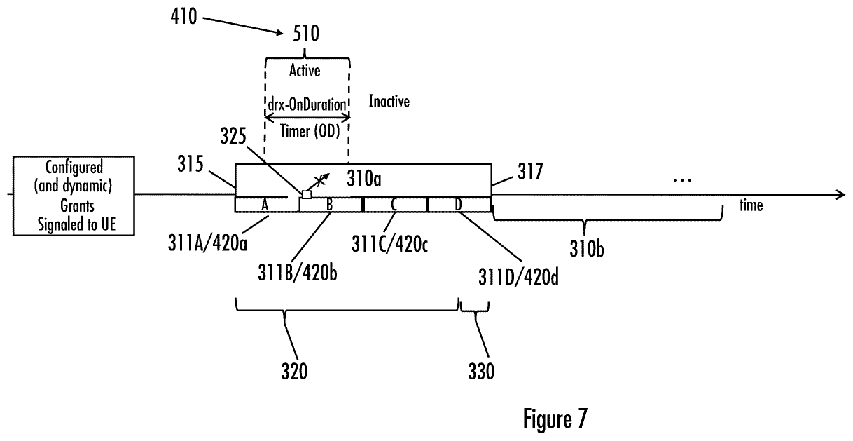

Turning now to FIG. 7, the disclosure points out a problem to the first scheduled transmission interval 310a caused by configured grants. In this scenario, each of blocks A, B, C, and D within the first scheduled transmission interval 310a, may represent a configured grant (311A, 311B, 311C, 311D) where the user equipment 120 may be blocked (325) from performing new or subsequent (dynamic) transmissions on the not yet transmitted physical uplink shared channels (PUSCH) 420b to 420n. The configured grants A-D may fall in a row such that they create a long anticipatively granted interval (LAGI), such as the first scheduled transmission interval 310a. The user equipment 120 may monitor for transmission scheduling information during a monitoring time 510, which occurs during the head end portion 320 of the first scheduled transmission interval 310a. However, this is not efficient as the user equipment 120 is blocked from new transmissions (on the PUSCH) until the conclusion of the transmission of configured grant D. It may be more efficient for monitoring time to occur during tail end portion 330 of the first scheduled transmission interval 310a, so that the subsequent scheduling information 340b for an uplink may be received by the UE just in time for a new transmission to begin within the subsequent scheduled transmission interval 310b.

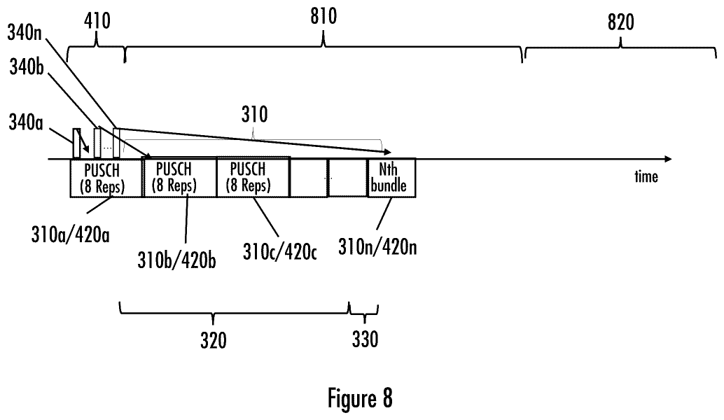

Turning now to FIG. 8, which illustrates an identified problem regarding a cell discontinuous transmission scenario. In this example, a network node 140 may provide uplink scheduling grants for transmission by the user equipment 120 during physical downlink control channel monitoring occasions 410. This may result in a plurality of physical uplink shared channel repetition bundles 420a to 420n being scheduled via dynamic and/or configured grants. In an example, a first scheduled transmission interval 310a may last until the final repetition bundle 420n has been transmitted. A network node 140 may be in a state of discontinuous transmission (cell DTX) during an entire scheduled transmission interval 810, and then resumes transmission during a subsequent scheduled transmission interval 820. The disclosure suggests that it may be more efficient for the user equipment 120 to instead be able to receive grants from the network node 140 during a tail end portion 330 of first scheduled transmission interval 310a.

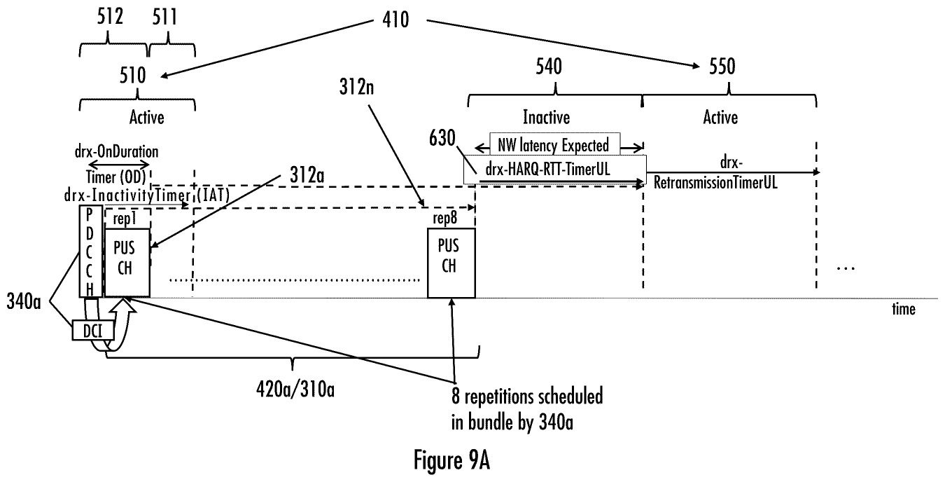

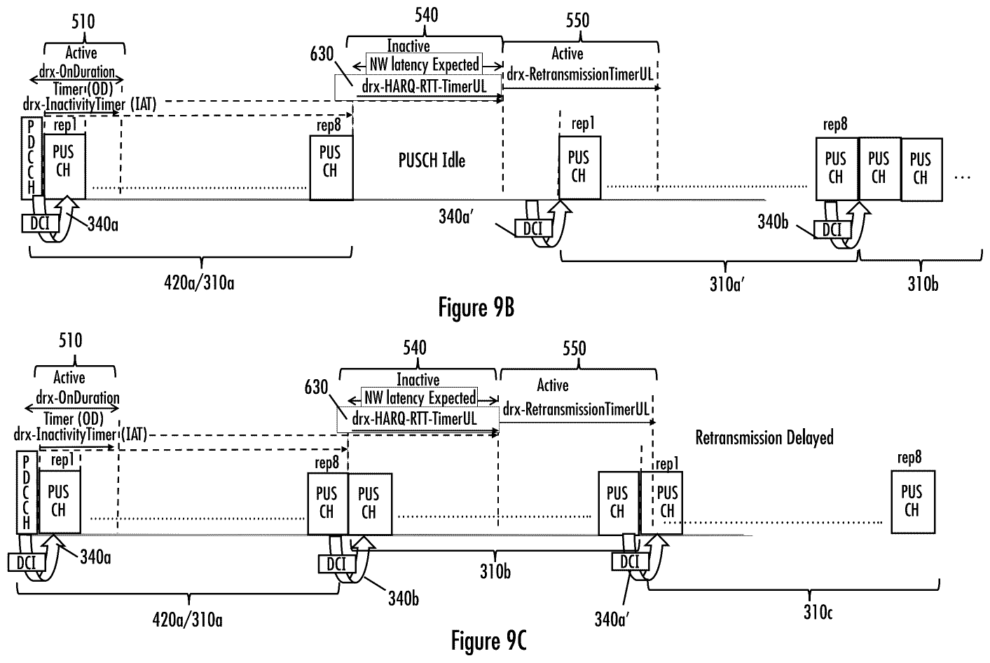

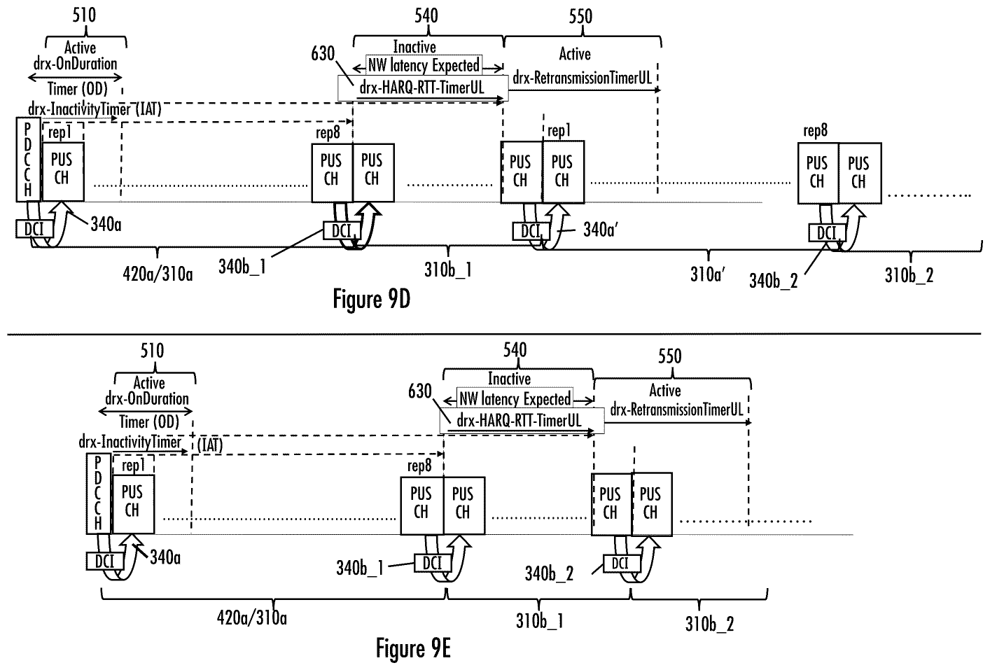

Turning now to FIG. 9A, for the disclosure points out a problem occurring with physical uplink shared channel (PUSCH) or physical downlink shared channel (PDSCH) allocation during and after a first scheduled transmission interval 310a. In this scenario, user equipment 120 may be scheduled to transmit a series of physical shared uplink channel repetition bundles 420a to 420n and receives downlink control information 340a via a physical downlink control channel (PDCCH), but this problem may occur when the user equipment 120 may be transmitting information via uplink and/or receiving information via downlink. During the monitoring period 510, the user equipment may be monitoring for transmission scheduling information. However, this monitoring time 510 may occur at the beginning of the first scheduled transmission interval 310. After the first scheduled transmission interval 310a, there may be an inactive period 540 where network latency is expected. Following the inactive period 540, there may be a next active period 550 where the user equipment 120 may monitor for downlink control information to signal a retransmission.

FIGS. 9B-9D illustrate the next active period 550 being delayed until after the inactive period 540. For example, FIG. 9B illustrates a scenario where user equipment 120 may be delayed in a subsequent scheduled transmission interval 310b until after determining if retransmission may be needed. At the beginning of an active period 550, user equipment 120 may receive downlink control information 340a′ indicating that retransmission of first scheduled transmission 420a interval 310a should be performed. At the conclusion of the retransmission, user equipment 120 may receive another downlink control information 340b scheduling a subsequent scheduled transmission interval 310b. This scenario is not ideal because the user equipment may not be transmitting anything during both the inactive period 540 and the beginning of active period 550. In order to maximize total user equipment transmission power, user equipment 120 needs to transmit during every uplink slot.

FIG. 9C illustrates a scenario where retransmission of the first scheduled transmission interval 310a may be delayed. In this scenario, the user equipment may begin a subsequent scheduled transmission interval 310b prior to the monitoring period 550. The user equipment 120 needs to first perform retransmission of the first scheduled transmission interval 310a but must wait until the subsequent scheduled transmission interval 310b is complete. This is inefficient because user equipment 120 may need to transmit retransmission quickly and avoid excess delay before a retransmission is complete. In addition, the retransmission of the first scheduled transmission interval 310a may be delayed relative to the normal retransmission window, which may require additional monitoring occasions.

FIG. 9D-9E illustrate a scenario where a shorter subsequent scheduled transmission interval 310b may be used to avoid unnecessarily delaying the retransmission of the first scheduled transmission interval 310a. For example, in FIG. 9D, a retransmission of the first scheduled transmission interval 310a may be needed. In FIG. 9E, a retransmission of the first scheduled transmission interval 310a may not be needed. This scenario is likewise inefficient because the subsequent scheduled transmission interval 310b may be shorter than needed. In this scenario, a network node 140 may not be able to dynamically select a number of repetitions for maximum physical uplink shared channel efficiency, because in order to avoid delaying the retransmission bundle (420b to 420n) the number of repetition selected needs to be reduced. In addition, in FIG. 9D, an extra downlink control information 910 (DCI) may be received over a physical downlink control channel (PDCCH) after retransmission to schedule repetitions that were omitted in the earlier grant for the subsequent scheduled transmission interval 310b. In FIG. 9E, the extra downlink control information 910 may be received after the subsequent scheduled transmission interval 310b, and the remaining repetitions of the subsequent scheduled transmission interval 310b may then be performed.

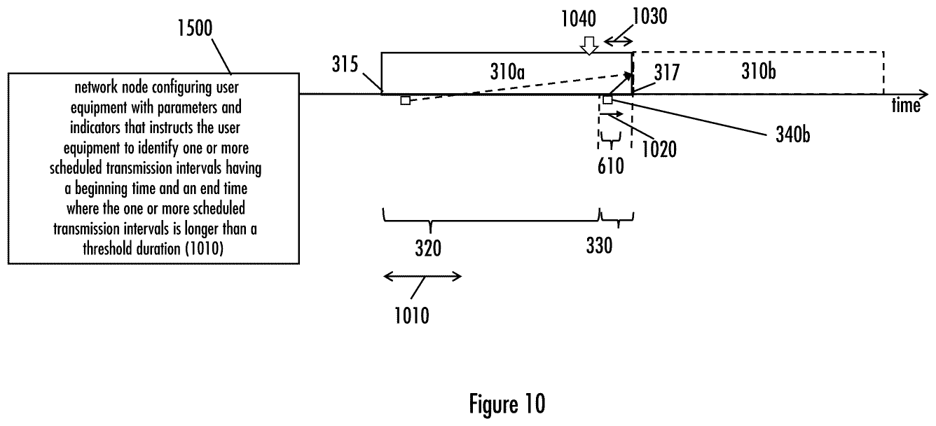

Turning now to FIG. 10, a high-level illustration of an example solution to the problem is provided. In one or more embodiments, a user equipment 120 identifies a first scheduled transmission interval 310a. In one or more embodiments, the first scheduled transmission interval 310a may have a beginning time 315 and an end time 317.

In one or more embodiments, the user equipment may determine a head end portion 320 and a tail end portion 330 of the first scheduled transmission interval 310a. In one or more embodiments, the user equipment 120 may determine the head end portion 320 and the tail end portion 330 based on the end time 317. For example, a user equipment 120 may use a tail offset time 1030 applied to the end time 317. In this example, the head end portion 320 may end at a time up to the tail offset time duration 1030 before the end time 317. In this example, the tail end portion 330 may begin at the tail offset time duration 1030 before the end time 317. Furthermore, in this example, the UE additionally may monitor for PDCCH grants during a tail active time duration (i.e. for a subsequent Ad Hoc duration interval) after this beginning time of tail end portion 330, such that the additional UE monitoring for PDCCH grants may end at the end time 317 or may end before or after the end time 317.

In one or more embodiments, the user equipment 120 may then monitor for a subsequent scheduling information 340b during the tail end portion 330 of first scheduled transmission interval 310a. In one or more embodiments, user equipment 120 may monitor for the next scheduling information 340b for a monitoring time duration 1020 equal or up to the length of the tail end portion 330. In one or more embodiments, scheduled monitoring time is removed from the head end portion 320 of the first scheduled transmission interval 310a and accommodated to the tail end portion 330 of the first scheduled transmission interval 310a. In one or more embodiments, the removed scheduled monitoring time for the transmission scheduling information during the head end portion 320 of the first scheduled transmission interval 310a resulted from one or more prior physical uplink shared channel grants. In one or more embodiments, at least one of the one or more prior scheduled physical uplink shared channel grants include repetitions 312a to 312n (see FIG. 9A). In one or more embodiments, when at least a portion of the initial uplink transmission 420a during the head end portion 320 is skipped (not transmitted) by the user equipment 120, the user equipment 120 may monitor for the initial transmission scheduling information 340a for a duration of a tail end portion 330 as updated to reflect the transmission which was skipped by the user equipment 120.

In one or more embodiments, the user equipment 120 adds monitoring time to the tail end portion 330 of first scheduled transmission interval 310a only if the first scheduled transmission interval 310a is longer than a threshold duration 1010. In one or more embodiments, if first scheduled transmission interval 310a is longer than a threshold duration 1010 (see FIG. 10), the user equipment 120 may determine that it is more efficient to wait until the end of first scheduled transmission interval 310a to monitor for the transmission of the subsequent scheduling information 340b.

In one or more embodiments, an indicator downlink control information 1040 may be used to signal if user equipment 120 needs to monitor for transmission of the subsequent scheduling information 340b during the tail end portion 330 of first scheduled transmission interval 310a. In one or more embodiments, the indicator downlink control information 1040 indicates whether or not transmission scheduling information will be transmitted by network node 140 and/or received by user equipment 120 during the tail end portion 330 of the first scheduled transmission interval 310a. In one or more embodiments, the indicator downlink control information 1040 may not be received by user equipment 120 and/or transmitted by network node 1040.

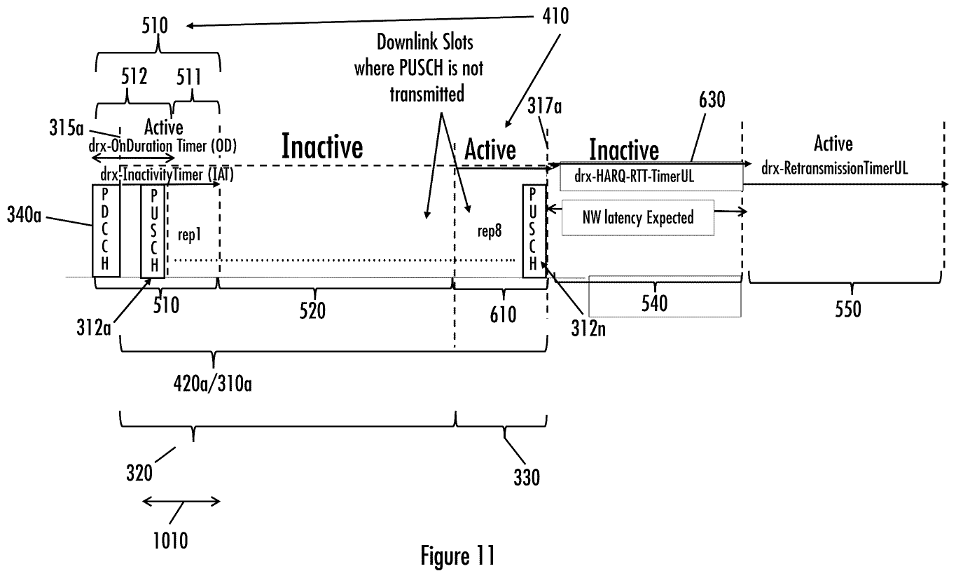

Turning now to FIG. 11, an illustration of an example solution is shown where the first scheduled transmission interval 310a includes repetitions 312a to 312n. In one or more embodiments, monitoring period 610 is accommodated at the tail end portion 330 of first scheduled transmission interval 310a. In one or more embodiments, during monitoring period 610, user equipment 120 monitors for transmission scheduling information. In one or more embodiments, at least part of monitoring period 510 may be removed and accommodated to monitoring period 610. In alternative embodiments, the monitoring period 610 may be accommodated without removing any of the monitoring period 510.

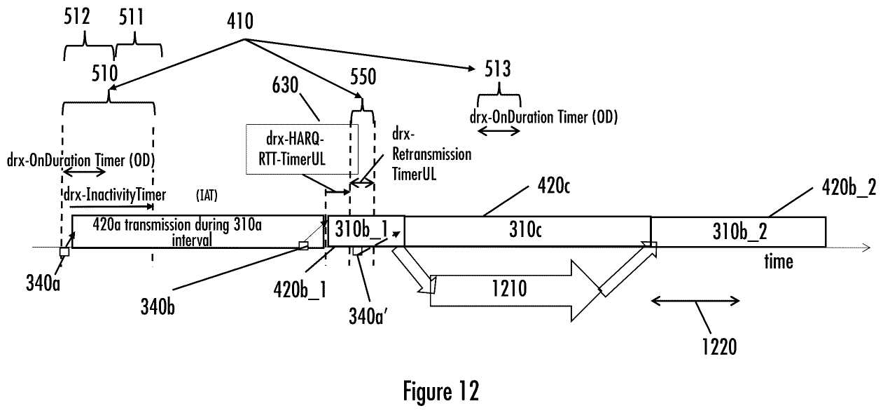

Turning now to FIG. 12, an illustration of an example solution is shown when to the physical uplink shared channel (PUSCH) or physical downlink shared channel (PDSCH) allocation problem presented in FIGS. 9A-9E. In one or more embodiments, physical uplink shared channel (PUSCH) repetitions 312a to 312n may be performed during the first scheduled transmission interval 310a, and a discontinuous reception (RTT) retransmission timer 630 may begin at the conclusion of the first scheduled transmission interval 310a while waiting for the network to determine if a retransmission 340a′ of the initial scheduling information is needed and prior to the DCI scheduling a retransmission. During this time, a next scheduled transmission interval may begin 310b. In one or more embodiments, at the expiration of the discontinuous reception retransmission timer 630, the user equipment 120 may monitor for a subsequent transmission scheduling information 340b, which is received during monitoring period 550 to schedule a retransmission 340a′ of the initial scheduling information during the first scheduled transmission interval 310a.

In one or more embodiments, operation 1210 may be performed by pausing (310b) after a portion (310b_1) of the subsequent scheduled transmission interval 310b/420b in order to perform a retransmission 420a′ of the initial scheduling information 340a of the first scheduled transmission interval 310a during a next subsequent scheduled transmission interval 310c. After the retransmission 340a′, the subsequent scheduling information 340b may be resumed through a non-contiguous a remainder portion (310b_2) of the subsequent scheduled transmission interval (310b), without a need for a separate DCI to schedule the resumption of the subsequent scheduled transmission interval 310b.

In one or more embodiments, only if a remainder 310b_2 of subsequent scheduled transmission interval 310b has a duration greater than a pause remainder threshold 1220, operation 1210 is performed by pausing the next scheduled transmission interval 310b, until after a retransmission 340a′ of the first scheduled transmission interval 310a. After the retransmission 340a′, the remainder 310b_2 may be transmitted. However, if a remainder 310b_2 of the subsequent scheduled transmission interval 310b is less than the pause remainder threshold 1220, then the user equipment 120 or the network node (e.g., gNB) 140 may determine that it may be more efficient to first finish a transmission of the next scheduled transmission interval 310b before performing retransmission 340a′ of the first scheduled transmission interval 310a. In this scenario, all uplink slots in each transmission interval may be used while minimizing the amount of DCIs.

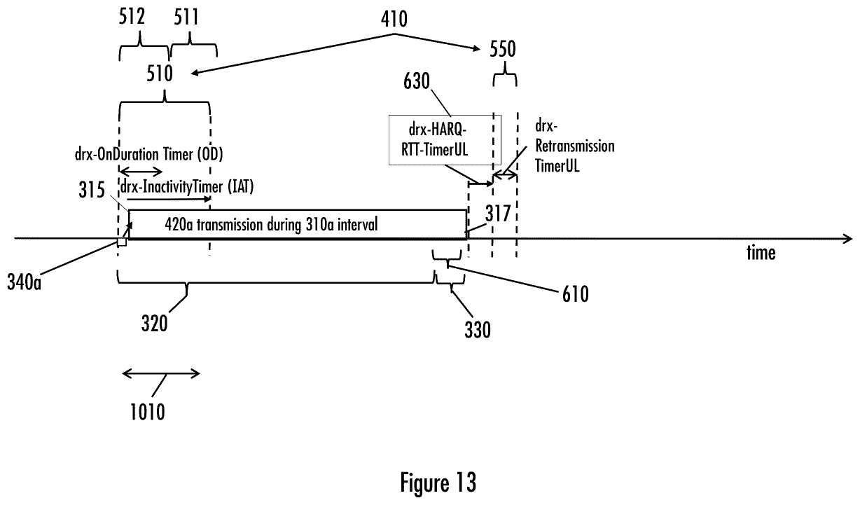

Turning now to FIG. 13, an example scenario where a solution to an inefficient monitoring period during the head end portion 320 may be implemented is illustrated. In one or more embodiments, the monitoring period 510 may occur during the head end portion 320 of the first scheduled transmission interval 310a, where the monitoring period 510 (or 511) may be removed from the head end portion 320 of the first scheduled transmission interval 310a, such as removing the interval 511 portion of the monitoring period 510, where the inactivity timer (IAT) may extend after the end of the on duration. In one or more embodiments, a monitoring period 610 may be accommodated to the tail end portion 330 of the first scheduled transmission interval 310a.

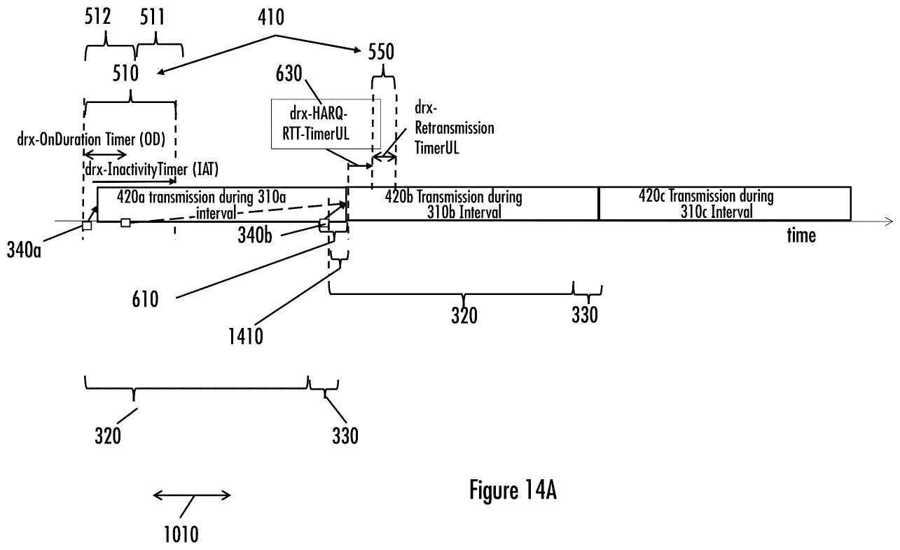

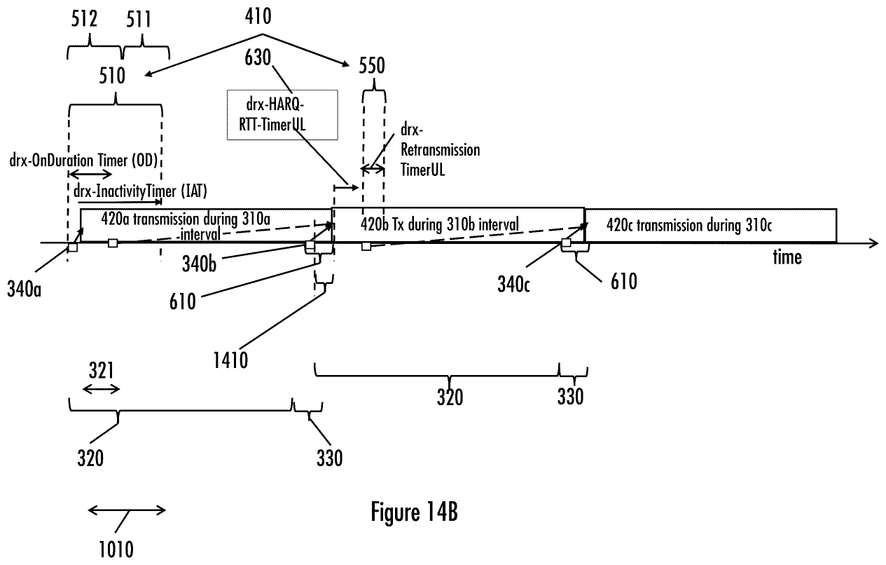

Turning now to FIG. 14A, which provides an example solution in a retransmission scenario. In one or more embodiments, the monitoring period 610 may be accommodated at the end of first scheduled transmission interval 310a. In one or more embodiments, a subsequent downlink control information (DCI) indicating subsequent transmission scheduling information 340b is to be received during the monitoring period 610. In one or more embodiments, once the subsequent downlink control information or the subsequent scheduling information 340b is received, a remainder portion 1410 of the monitoring period 610 may be canceled without being monitored by the UE) if the subsequent downlink control information 340b that scheduled the UE 120 with the long anticipatively-granted interval (LAGI), such that the user equipment may avoid additional monitoring time until the tail end portion of the scheduled transmission interval 310b. In one or more embodiments, the remainder portion 1410 of the monitoring period 610 may be reallocated to the tail end portion 320 of scheduled next transmission interval 310b. In one or more embodiments, during the head end portion 320 of the next scheduled transmission interval 310b, the user equipment 120 may not monitor for the subsequent transmission scheduling information 340b. In one or more embodiments, in response to receiving a new or subsequent uplink transmission information 340b for transmission 420b, the user equipment 120 may stop monitoring for the new or subsequent uplink transmission information 340c received during a remainder portion 1410 of the tail end portion 330 of the first scheduled transmission interval 310a. In one or more embodiments, in response to receiving a new or subsequent uplink transmission information 340b, the user equipment 120 may stop monitoring for the new or subsequent transmission information 340c until the tail end portion 330 of the subsequent scheduled transmission interval 310b, which more monitoring time may then be accommodated to the tail end portion 330 of the next scheduled transmission interval 310b. In case when the new or subsequent downlink control information 340b is not received, the user equipment 120 may stop monitoring for uplink transmission information 420b when the next scheduled transmission interval 310b begins.

Turning now to FIG. 14B, an example scenario where new or subsequent downlink control information 340c may be received during the monitoring period 550. In one or more embodiments, operation 1950 a portion or all of the monitoring period 550 is not monitored during the head end portion 320 of the subsequent scheduled transmission interval 310b. More specifically, the monitoring period 550 may be moved from the head end portion 320 of the subsequent scheduled transmission interval 310b to the tail end portion 330 of a subsequent scheduled transmission interval 310b. In one or more embodiments, the monitoring period 550 during the head end portion 320 of the subsequent scheduled transmission interval 310b may be moved by increasing the discontinuous reception retransmission timer 630.

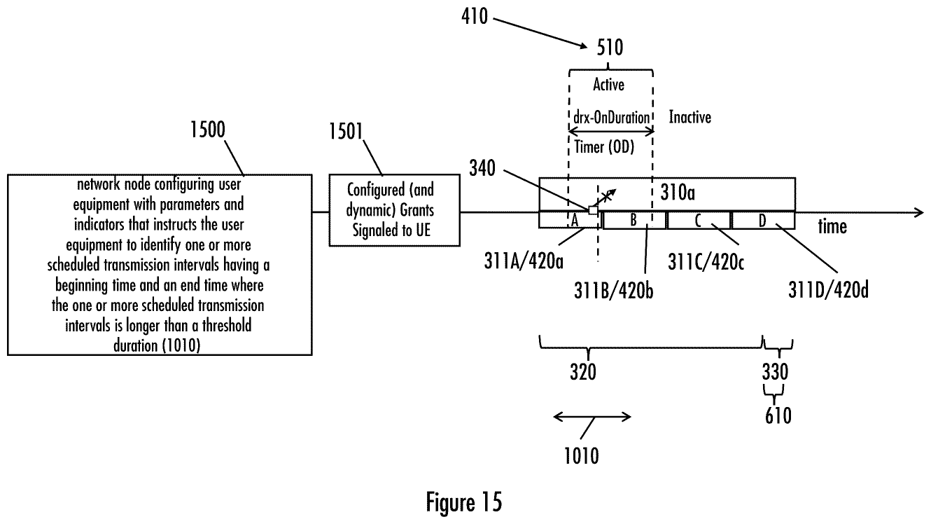

Turning now to FIG. 15, an example scenario where configured grants for PUSCH 311A-311D may create a first scheduled transmission interval 310a. In one or more embodiments, operation 1500 provides the user equipment 120 with parameters and indicators to perform monitoring time during the tail end portion 330. The example parameters and indications may be received from the network node 140 on downlink via radio resource control. In one or more embodiments, the monitoring period 510 may be illustrated as taking place during a head end portion 320 of first scheduled transmission interval 310a, which the monitoring time 510 may be moved to the tail end portion 330 of first scheduled transmission interval 310a. In one or more embodiments, the monitoring period 610 may be accommodated to the tail end portion 330 of first scheduled transmission interval 310a to enable better efficiency for the monitoring period 510 to take place during the tail end portion 330, so that the new or subsequent uplink transmission information (420b) may be received just prior to a transmission.

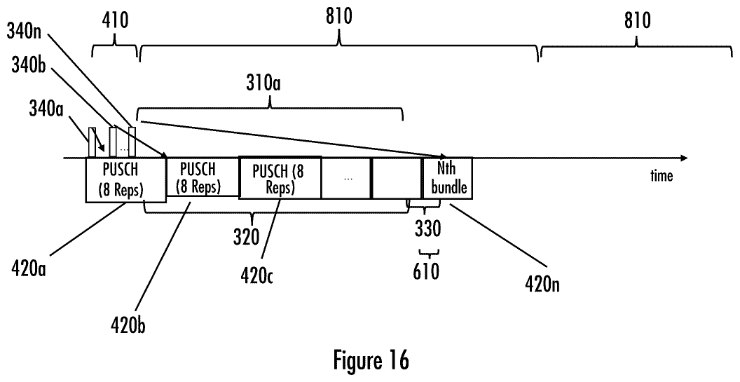

Turning now to FIG. 16, an example solution is provided for a cell discontinuous transmission scenario. In one or more embodiments, during physical downlink control channel monitoring occasions 410, a network node 140 may provide uplink scheduling grants (340a to 340n). In one or more embodiments, this results in a plurality of physical uplink shared channel (PUSCH) repetition bundles 420a to 420n being scheduled. In one or more embodiments, physical uplink shared channel repetition bundles may be scheduled via dynamic and/or configured grants (340a to 340n). In one or more embodiments, the first scheduled transmission interval 310a may last until the final repetition bundle 420n has been transmitted. In one or more embodiments, network node 140 may be in a state of discontinuous transmission during a time interval 810 and may resume transmission during the time interval 820. In one or more embodiments, the monitoring period 610 may be accommodated to the tail end portion 330 of the first scheduled transmission interval 310a. In one or more embodiments, the monitoring period 610 may be removed from the head end portion 320 of the first scheduled transmission interval and accommodated to a tail end portion 330 of the first scheduled transmission interval 310a. In one or more embodiments, the monitoring period 610 is in response to an uplink or downlink discontinuous reception inactivity or in response to a retransmission timer for uplink or downlink traffic. This provides an example solution by allowing the network node 140 to wake up just in time to schedule the user equipment to start uplink transmission immediately after first scheduled transmission interval 310a.

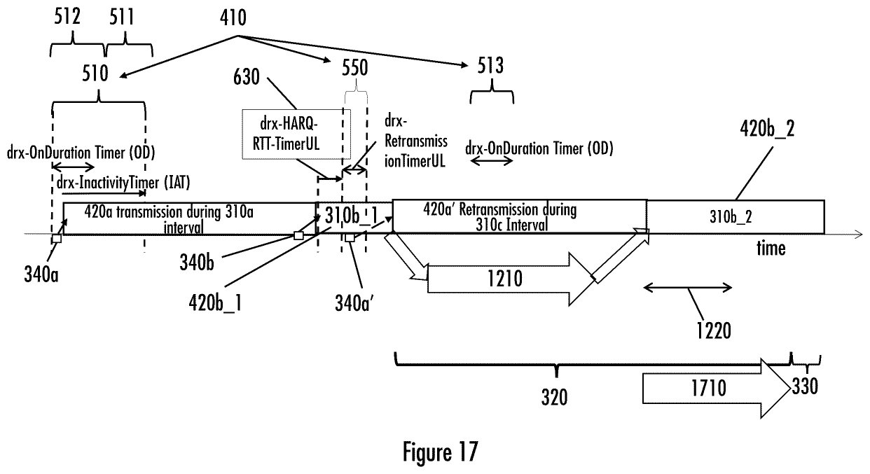

Turning now to FIG. 17, which provides an illustration of an example solution adding detail to the example solution shown in FIG. 12. In one or more embodiments, a first scheduled transmission interval 310a may be retransmitted 420a′ in a next subsequent transmission interval 310c. In one or more embodiments, pausing operation 1210 may be performed to execute a pause during a first portion 310b_1 of the subsequent scheduled transmission interval 310b, and later resumed after the retransmission 340a′ of the first scheduled transmission interval 310a. In one or more embodiments, a head end portion 320 and a tail end portion 330 may encompass an entirety of the retransmission 420a′ of the first scheduled transmission interval 310a and finish remaining transmission 420b_2 during the remainder 310b_2 of the subsequent scheduled transmission interval 310b respectively. In one or more embodiments, the monitoring period 513 may be removed from head end 320 of 320c and 310b_2 in FIG. 17. In one or more embodiments, the monitoring period 513 may be accommodated to the tail end portion 330 of 320c and 310b_2 in FIG. 17. In one or more embodiments, at operation 1710, the monitoring period 513 may be moved from a head end portion 320 to a tail end portion 330. In one or more embodiments, this allows transmissions scheduling information to be received just prior to the end of subsequent scheduled transmission interval 310b, allowing fresh information for future transmissions.

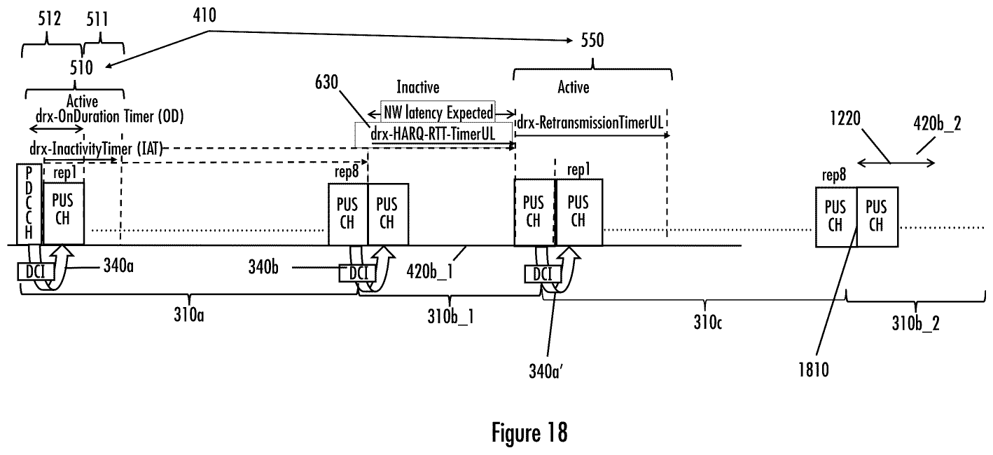

Turning now to FIG. 18, an example solution is shown for physical uplink shared channel allocation timing. In one or more embodiments, a first scheduled transmission interval 310a including repetitions 312a to 312n may be performed in response to an initial scheduling information 340a (downlink control information) on physical downlink control channel. In one or more embodiments, at the expiration of first scheduled transmission interval 310a, a subsequent scheduled transmission interval 310b is performed by user equipment 120. During the subsequent scheduled transmission interval 310b and monitoring period 550, user equipment 120 may receive a subsequent downlink control information 340b indicating that a retransmission 340a′ of the first scheduled transmission interval 310a may be performed. The subsequent scheduled transmission interval 310b may be paused and retransmission 340a′ of the first scheduled transmission interval 310 may be performed. At time 1810, the retransmission 340a′ of the first scheduled transmission interval 310 may end and the next scheduled transmission interval 310b may resume without a need to receive a next or another scheduling information 340b or 340b_2 (downlink control information).

In one or more embodiments, the subsequent scheduled transmission interval 310b is paused, only if a remainder portion 310b_2 of the subsequent scheduled transmission interval 310b is greater than a pause remainder threshold 1220. In one or more embodiments, if the remainder portion 310b_2 of the subsequent scheduled transmission interval 310b (length of the portion of next retransmission interval 310b which is not yet transmitted at the time 340b is received) is less than pause remainder threshold 1220, the user equipment 120 or network node gNB 140 may determine to first finish the next scheduled transmission interval 310b prior to retransmitting 340a′ the first scheduled transmission interval 310a (as that is likely more efficient).

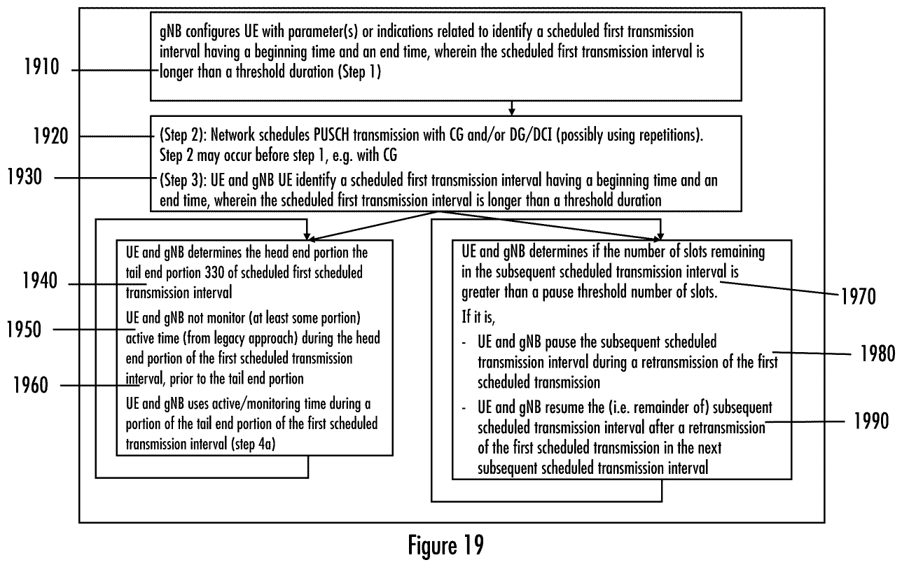

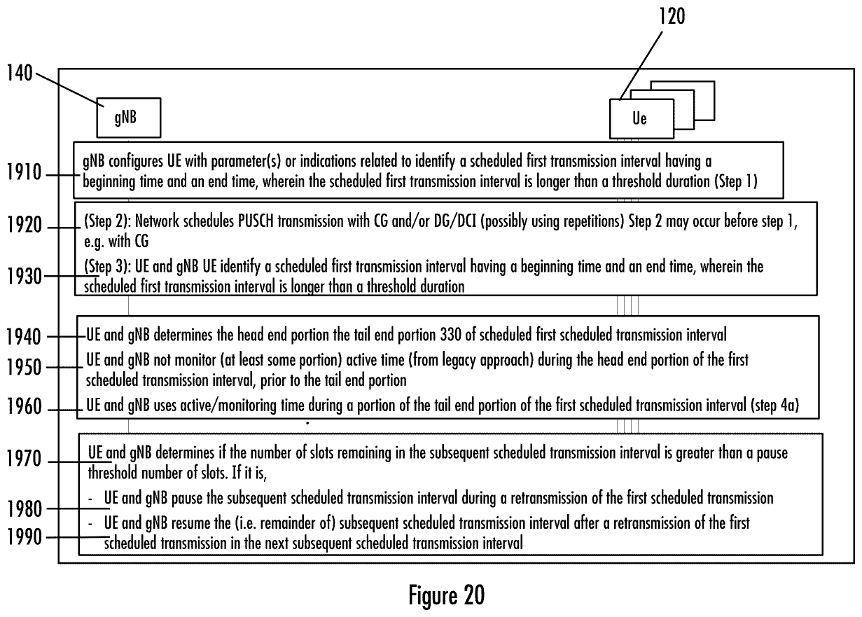

Turning now to FIG. 19, an example flowchart is shown, depicting operations performed by, for example, user equipment 120 and/or network node 140.

In one or more embodiments, at operation 1910, a network node 140 configured a user equipment with parameters or indications relative to identifying a sufficiently long anticipatively granted interval. In one or more embodiments, a sufficiently long anticipatively granted interval is a first scheduled transmission interval. For example, a first scheduled transmission interval may be an already first scheduled transmission interval. For example, one or more physical uplink shared channel grants may have already scheduled the user equipment 120 to transmit during the first scheduled transmission interval. In one or more embodiments, the user equipment 120 may not process additional transmission scheduling information that instructs the user equipment to transmit during the first scheduled transmission interval. In one or more embodiments, identifying a first scheduled transmission interval includes identifying that the user equipment is blocked from scheduling new transmissions for at least a threshold percentage of the first scheduled transmission interval. In one or more embodiments, a sufficiently long anticipatively granted interval is a scheduled next transmission interval. In one or more embodiments, the sufficiently long anticipatively granted interval may include physical uplink shared channel transmissions or physical downlink shared channel transmissions. In one or more embodiments, network node 140 configures user equipment with parameters and indications to identify a sufficiently long anticipatively granted interval. For example, network node 140 may configure user equipment 120 to identify first scheduled transmission intervals and/or scheduled next transmission intervals with lengths or transmission percentages greater than threshold amounts.

In one or more embodiments, at operation 1920, a network schedules physical uplink shared channel and/or physical downlink shared channel transmissions. In one or more embodiments, the transmissions are scheduled by configured grants. In one or more embodiments, the transmissions are scheduled by dynamic grants. In one or more embodiments, the transmissions are scheduled by downlink control information. In one or more embodiments, operation 1920 may occur before or after operation 1910.

In one or more embodiments, at operation 1930, a user equipment 120 and/or a network node 140 may identify a sufficiently long anticipatively granted interval. For example, a user equipment 120 and/or a network node 140 may identify a first scheduled transmission interval and/or a scheduled next transmission interval that meets criteria configured at operation 1910. In one or more embodiments, the sufficiently long anticipatively granted interval results from physical uplink shared channel grants and/or physical downlink shared channel grants. In one or more embodiments, a first scheduled transmission interval and/or scheduled next transmission interval may be longer than a threshold duration received from network node 140. In one or more embodiments, the threshold duration is received via radio resource control by user equipment 120.

In one or more embodiments, at operation 1940, a user equipment 120 and/or a network node 140 may determine when a tail end portion 330 of a first scheduled transmission interval 310 or a scheduled next transmission interval 610 starts. In one or more embodiments, user equipment 120 and/or network node 140 determine the timing of tail end portion 330 based on at least one of a tail offset time 1030 and a tail active time duration. In one or more embodiments, user equipment 120 and/or network node 140 identify a head end portion 320 and/or a tail end portion 330 of the first scheduled transmission interval 310 or the scheduled next transmission interval 610. In one or more embodiments, at least one of the head end portion 320 or the tail end portion 330 includes a predetermined number of slots.

In one or more embodiments, at operation 1950, a user equipment 120 and/or network node 140 may determine not to monitor for transmission scheduling information during a head end portion 20 of a first scheduled transmission interval 310a or a scheduled next transmission interval 310b. In one or more embodiments, the head end portion 320 of the first scheduled transmission interval 310a or the scheduled next transmission interval 310b occurs prior to the tail end portion 330 of the first scheduled transmission interval 310 or the scheduled next transmission interval 310b. For example, user equipment 120 and/or network node 140 may remove monitoring time 510. In some embodiments, operation 1950 is skipped and proceeds directly to step 1960.

In one or more embodiments, at operation 1960, a user equipment 120 and/or a network node 140 may monitor for transmission scheduling information during a tail end portion 330 of a first scheduled transmission interval 310 or a scheduled next transmission interval 610. For example, user equipment 120 and/or network node 140 may add monitoring time 610 to the tail end portion 330 of first scheduled transmission interval 310 or scheduled next transmission interval 610.

In one or more embodiments, at operation 1970, a user equipment 120 and/or network node 140 determine if a number of slots remaining in a scheduled next transmission interval 420 is greater than a pause remainder threshold 1220. In one or more embodiments, if the number of slots remaining in a scheduled next transmission interval 420 is less than the pause remainder threshold 1220, the user equipment 120 and/or network node 140 finish performing the scheduled next transmission interval 610.

In one or more embodiments, at operation 1980, user equipment 120 and/or network node 140 determine that the slots remaining in the first scheduled transmission interval or the scheduled next transmission interval 420 is greater than the pause remainder threshold 1210. In one or more embodiments, user equipment 120 and/or network node 140 pause the first scheduled transmission interval or the scheduled next transmission interval 610. In one or more embodiments, user equipment 120 and/or network node 140 perform a retransmission of first scheduled transmission interval 120.

In one or more embodiments, at operation 1990, user equipment 120 and/or network node 140 resume the first scheduled transmission interval or the scheduled next transmission interval 420 after a retransmission window. In one or more embodiments, no downlink control information 340 need be received by user equipment 120 to finish performing the next transmission interval 610.

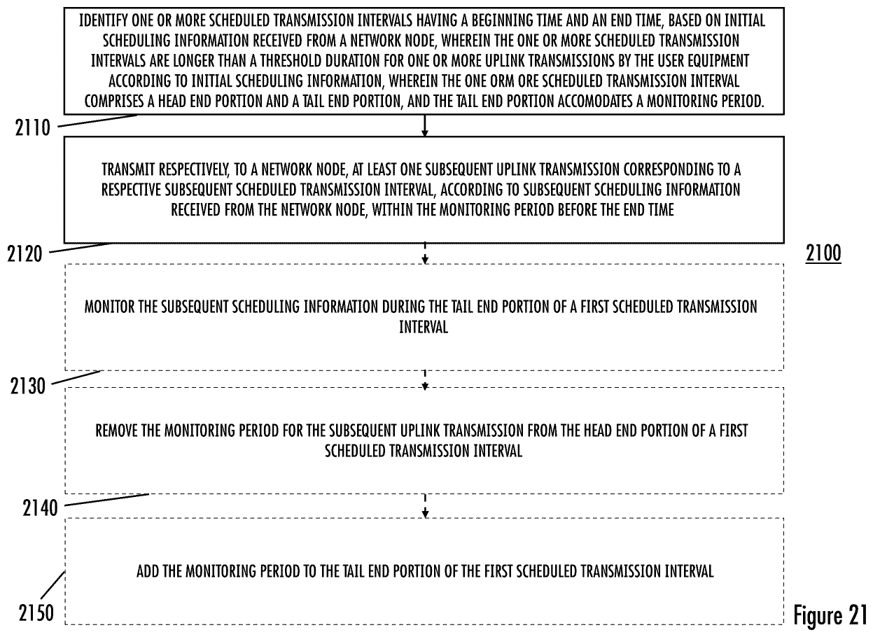

Turning now to FIG. 21, an example flowchart is illustrated for a process 2100 performed by an apparatus embodied by, associated with or otherwise in communication with (hereinafter generally referenced as being embodied by) a user equipment 120 to transmit an uplink transmission to a network node 140.

As shown in block 2110 of FIG. 21, the apparatus embodied by the user equipment 120 includes means, such as the processing circuitry 220, the communication interface 260, or the like, for identifying (1930) one or more scheduled transmission intervals (310a . . . 310n) having a beginning time (315) and an end time (317), based on initial scheduling information (340a) received from a network node (140), wherein the one or more scheduled transmission intervals (310a . . . 310n) is longer than a threshold duration (1010) for one or more uplink transmissions (420a . . . 420n) by the user equipment (120) according to initial scheduling information (340a), wherein the one or more scheduled transmission intervals (310a . . . 310n) comprises a head end portion (320) and a tail end portion (330), and the tail end portion (330) accommodates a monitoring period (610). In one or more embodiments, the scheduled transmission interval enables the user equipment (120) to transmit during the first scheduled transmission interval (310a) according to one or more physical uplink shared channel (PUSCH) grants (311A to 311D). In one or more embodiments, the scheduled transmission interval enables the user equipment (120) to stop processing additional transmission scheduling information (325) that instructs the user equipment (120) to transmit during the first scheduled transmission interval (310a). In one or more embodiments, the identifying (1930) of the first scheduled transmission interval (310) having the beginning time (315) and the end time (317) comprises the user equipment (120) is configured to be blocked (325) from scheduling new transmissions for at least a percentage of the threshold duration (1010) of the first scheduled transmission interval (310). In one or more embodiments, at least one of the head end portion (320) or the tail end portion (330) of the first scheduled transmission interval (310) comprises a predetermined number (1010) of slots (312a . . . 312n). In one or more embodiments, the user equipment (120) is further caused to receive (1910) the threshold duration (1010) from the network node (140). In one or more embodiments, the threshold duration (1010) is received via radio resource control.

As shown in block 2120 of FIG. 21, the apparatus embodied by the user equipment 120 includes means, such as the processing circuitry 220, the communication interface 260, or the like, for transmit respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317). In one or more embodiments, the subsequent scheduling information (340b . . . 340n) (i.e., DCI) is transmitted by the network node (140) to the user equipment (120) during the monitoring period (610) of the tail end portion (330) before the end time (317), to allocate the subsequent scheduled transmission interval (310b . . . 310n) for the subsequent uplink transmission (420b . . . 420n) (PUSCH) by the user equipment (120). In one or more embodiments, the user equipment (120) is further caused to receive new transmission scheduling information (340b in FIG. 14B) during the tail end portion (330) of the first scheduled transmission interval (310a). In one or more embodiments, in response to receiving the subsequent transmission scheduling information (340b), the user equipment (120) is further caused to stop monitoring for a next subsequent transmission scheduling information (340c) during at least one of (i) (1410) a remainder of the tail end portion (610/330) of the first scheduled transmission interval (310a), or (ii) the head end portion (320) of the subsequent scheduled transmission interval (310b). In one or more embodiments, when a number of slots (i.e., a portion of 312a to 312n) remaining in the subsequent transmission interval (310b) is greater (1970) than a pause threshold number of slots (1220), the user equipment (120) is further caused to pause (1980) the subsequent scheduled transmission interval. In one or more embodiments, the user equipment (120) is further caused to resume (1990) the subsequent scheduled transmission interval (310b) after a retransmission of the first scheduled transmission (420a′) in the next subsequent scheduled transmission interval.

As shown in optional block 2130 of FIG. 21, the apparatus embodied by the user equipment 120 includes means, such as the processing circuitry 220, the communication interface 260, or the like, for monitoring (1960) the subsequent scheduling information (340b . . . 340n) during the tail end portion (330) of a first scheduled transmission interval (310a). In one or more embodiments where transmission is skipped by the user equipment 9120) for at least a portion (321) of the head end portion (320), the user equipment (120) is further caused to monitor for the subsequent scheduling information (340b) for a duration of the tail end portion (330) of the first scheduled transmission interval (310a) as updated to reflect the transmission has been skipped for at least the portion (321) of the head end portion (320) by the user equipment (120). In one or more embodiments, the user equipment (120) is further caused to stop monitoring for the next subsequent transmission scheduling information (340c . . . 340n) when the subsequent scheduled transmission interval (310b) begins.

As shown in optional block 2140 of FIG. 21, the apparatus embodied by the user equipment 120 includes means, such as the processing circuitry 220, the communication interface 260, or the like, for removing (1950) the monitoring period (511 or 550 or 513) for the subsequent uplink transmission (420b . . . 420n) from the head end portion (320) of a first scheduled transmission interval (310a). In one or more embodiments, the removal of monitoring time (511 or 550—see FIG. 14B) for the subsequent transmitted information (340b . . . 340n) during the head end portion (320) of the first scheduled transmission interval (310a) resulted from one or more priorly scheduled physical uplink shared channel (PUSCH) grants (340a). In one or more embodiments, at least one of the one or more priorly scheduled physical uplink shared channel (PUSCH) grants (340a . . . 340n) schedules respective PUSCH repetitions.

As shown in optional block 2150 of FIG. 21, the apparatus embodied by the user equipment 120 includes means, such as the processing circuitry 220, the communication interface 260, or the like, for adding (1960) the monitoring period (610) to the tail end portion (330) of the first scheduled transmission interval (310a). In one or more embodiments, the monitoring period (610) is accommodated to the tail end portion (330) of the first scheduled transmission interval (310a), or the subsequent scheduled transmission interval (310b) by increasing a discontinuous reception retransmission timer (630).

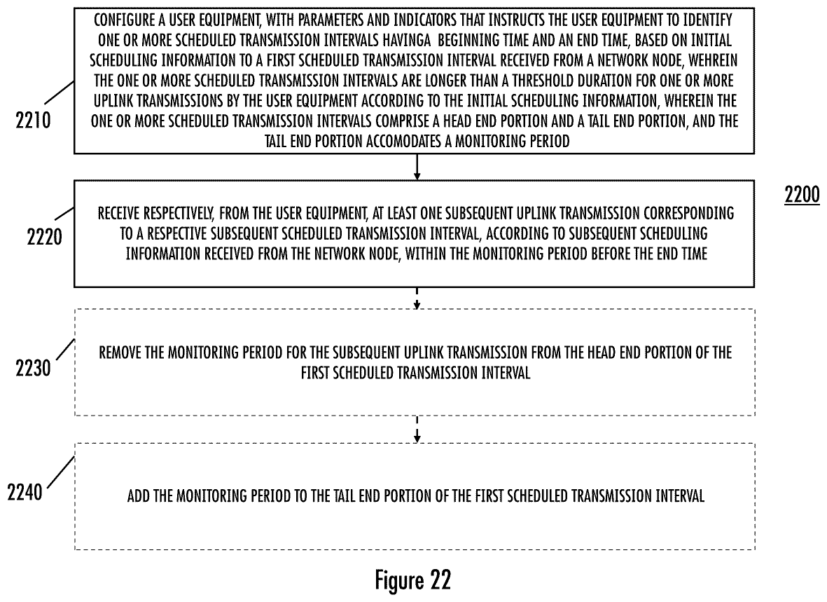

Turning now to FIG. 22, an example flowchart is illustrated for a process 2200 performed by an apparatus embodied by, associated with or otherwise in communication with (hereinafter generally referenced as being embodied by) a network node 140 to receive uplink transmissions from a user equipment 120.

As shown in block 2210 of FIG. 22, the apparatus embodied by the network node 140 includes means, such as the processing circuitry 220, the communication interface 260, or the like, for configuring (1910), a user equipment (120), with parameters and indicators (1500) that instructs the user equipment (120) to identify one or more scheduled transmission intervals (310a . . . 310n) having a beginning time (315) and an end time (317), based on initial scheduling information (340a) to a first scheduled transmission interval (310a) received from a network node (140), wherein the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) comprises a head end portion (320) and a tail end portion (330), and the tail end portion (330) accommodates a monitoring period (610). In one or more embodiments, the monitoring period (610) is accommodated to the tail end portion (330) of the first scheduled transmission interval (310a), or the subsequent scheduled transmission interval (310b) by increasing a discontinuous reception retransmission timer (630). In one or more embodiments, the scheduled transmission interval (310 in FIG. 15) enables the user equipment (120) to perform at least one of (i) transmit during the first scheduled transmission interval (310a) according to one or more physical uplink shared channel (PUSCH) grants (311A to 311D), or (ii) stop processing additional transmission scheduling information (325) that instructs the user equipment (120) to transmit during the first scheduled transmission interval (310a). In one or more embodiments, the identifying (1930) of the first scheduled transmission interval (310) having the beginning time (315) and the end time (317) comprises the user equipment (120) is configured to be blocked from scheduling new transmissions for at least a percentage of the threshold duration (1010) of the first scheduled transmission interval (310). In one or more embodiments, at least one of the head end portion (320) or the tail end portion (330) of the first scheduled transmission interval (310) comprises a predetermined number of slots (312a . . . 312n). In one or more embodiments, the network node (140) is further caused to configure the user equipment (120) with the threshold duration (1010) via radio resource control.

As shown in block 2220 of FIG. 22, the apparatus embodied by the network node 140 includes means, such as the processing circuitry 220, the communication interface 260, or the like, for receiving respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317). In one or more embodiments, the subsequent scheduling information (340b . . . 340n) (i.e., DCI) is transmitted by the network node (140) to the user equipment (120) during the monitoring period (610) of the tail end portion (330) before the end time (317), to allocate the subsequent scheduled transmission interval (310b . . . 310n) for the subsequent uplink transmission (420b . . . 420n) (PUSCH) by the user equipment (120). In one or more embodiments, the network node (140) is further caused to transmit to the user equipment (120), new transmission scheduling information (340b in FIG. 14B) during the tail end portion (330) of the first scheduled transmission interval (310a). In one or more embodiments, in response to receiving the subsequent transmission scheduling information (340b), the network node is further caused to stop monitoring for a next subsequent transmission scheduling information (340c) during at least one of (i) (1410) a remainder of the tail end portion (610/330) of the first scheduled transmission interval (310a), or (ii) the head end portion (320) of the subsequent scheduled transmission interval (310b). In one or more embodiments, the network node (140) is further caused to configure a user equipment to, when a number of slots (i.e., a portion of 312a to 312n) remaining in the subsequent scheduled transmission interval (310b) is greater (1970) than a pause threshold number of slots (1220), pause (1980) the subsequent scheduled transmission interval (310b). In one or more embodiments, the network node (140) is further caused to configure (1910) the user equipment (120) to resume (1990) the subsequent scheduled transmission interval (310b) after a retransmission of the first scheduled transmission (420a′) in the next subsequent scheduled transmission interval (310c).

As shown in optional block 2230 of FIG. 22, the apparatus embodied by the network node 140 includes means, such as the processing circuitry 220, the communication interface 260, or the like, for removing (1950) the monitoring period (511 or 550) for the subsequent uplink transmission (420b . . . 420n) from the head end portion (320) of the first scheduled transmission interval (310a). In one or more embodiments, the removal of monitoring time (511 or 550—see FIG. 14B) for the subsequent transmitted information (340b . . . 340n) during the head end portion (320) of the first scheduled transmission interval (310a) resulted from one or more priorly scheduled physical uplink shared channel (PUSCH) grants (340a). In one or more embodiments, at least one of the one or more priorly scheduled physical uplink shared channel (PUSCH) grants (340A to 340D) schedules respective PUSCH repetitions.

As shown in optional block 2240 of FIG. 22, the apparatus embodied by the network node 140 includes means, such as the processing circuitry 220, the communication interface 260, or the like, for adding (1960) the monitoring period (610) to the tail end portion (330) of the first scheduled transmission interval (310a). In one or more embodiments where transmission is skipped by the user equipment (120) for at least a portion (321) of the head end portion (320), the user equipment (120) is further caused to monitor for the subsequent scheduling information (340b) for a duration of the tail end portion (330) of the first scheduled transmission interval (310a) as updated to reflect the transmission has been skipped for at least the portion (321) of the head end portion (320) by the user equipment (120). In one or more embodiments, when the network node (140) monitors for the subsequent transmission scheduling information (340b . . . 340n), the network node (140) is further caused to configure (1910) the user equipment (120) to stop monitoring for the next subsequent transmission scheduling information (340c . . . 340n) when the subsequent scheduled transmission interval (310b) begins.

FIGS. 21-22 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 240 of an apparatus employing an embodiment and executed by a processor 220. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In one or more embodiments, a user equipment (120) is provided, including at least one processor and at least one memory storing instructions that, when executed by the processor, cause the user equipment (120) to identify (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the user equipment (120) is further caused to transmit respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, the user equipment (120) is further caused to monitor (1960) the subsequent scheduling information (340b . . . 340n) during the tail end portion (330) of a first scheduled transmission interval (310a).

In one or more embodiments, the subsequent scheduling information (340b . . . 340n) (i.e., DCI) is transmitted by the network node (140) to the user equipment (120) during the monitoring period (610) of the tail end portion (330) before the end time (317), to allocate the subsequent scheduled transmission interval (310b . . . 310n) for the subsequent uplink transmission (420b . . . 420n) (PUSCH) by the user equipment (120).

In one or more embodiments, the user equipment (120) is further caused to remove (1950) the monitoring period (511 or 550 or 513) for the subsequent uplink transmission (420b . . . 420n) from the head end portion (320) of a first scheduled transmission interval (310a). In one or more embodiments, the user equipment (120) is further caused to add (1960) the monitoring period (610) to the tail end portion (330) of the first scheduled transmission interval (310a).

In one or more embodiments, the monitoring period (610) is accommodated to the tail end portion (330) of the first scheduled transmission interval (310a), or the subsequent scheduled transmission interval (310b) by increasing a discontinuous reception retransmission timer (630).

In one or more embodiments, the scheduled transmission interval (310 in FIG. 15) enables the user equipment to perform at least one of (i) transmit during the first scheduled transmission interval (310a) according to one or more physical uplink shared channel (PUSCH) grants (311A to 311D), or (ii) stop processing additional transmission scheduling information (325) that instructs the user equipment (120) to transmit during the first scheduled transmission interval (310a).

In one or more embodiments, the removal of monitoring time (511 or 550—see FIG. 14B) for the subsequent transmitted information (340b . . . 340n) during the head end portion (320) of the first scheduled transmission interval (310a) resulted from one or more priorly scheduled physical uplink shared channel (PUSCH) grants (340a).

In one or more embodiments, at least one of the one or more priorly scheduled physical uplink shared channel (PUSCH) grants (340a . . . 340n) schedules respective PUSCH repetitions.

(FIG. 15) In one or more embodiments, the identifying (1930) of the first scheduled transmission interval (310) having the beginning time (315) and the end time (317) comprises the user equipment (120) is configured to be blocked (325) from scheduling new transmissions for at least a percentage of the threshold duration (1010) of the first scheduled transmission interval (310).

(See FIG. 11 element 1010 and 312a . . . 312n, (or FIG. 12, 13, 14)) In one or more embodiments, at least one of the head end portion (320) or the tail end portion (330) of the first scheduled transmission interval (310) comprises a predetermined number (1010) of slots (312a . . . 312n).

(See FIG. 14B) In one or more embodiments, the user equipment (120) is further caused to receive new transmission scheduling information (340b in FIG. 14B) during the tail end portion (330) of the first scheduled transmission interval (310a). In one or more embodiments, the user equipment (120) is further caused to, in response to receiving the subsequent transmission scheduling information (340b), stop monitoring for a next subsequent transmission scheduling information (340c) during at least one of: (i) (1410) a remainder of the tail end portion (610/330) of the first scheduled transmission interval (310a), or (ii) the head end portion (320) of the subsequent scheduled transmission interval (310b).

(See FIG. 4B) In one or more embodiments, the user equipment (120) is further caused to receive (1910) the threshold duration (1010) from the network node (140).

In one or more embodiments, the threshold duration (1010) is received (1910) via radio resource control.

(See FIG. 14B/321) In one or more embodiments, in a situation that transmission is skipped by the user equipment for at least a portion (321) of the head end portion (320), the user equipment (120) is further caused to monitor for the subsequent scheduling information (340b) for a duration of the tail end portion (330) of the first scheduled transmission interval (310a) as updated to reflect the transmission has been skipped for at least the portion (321) of the head end portion (320) by the user equipment (120).

In one or more embodiments, when the user equipment (120-FIG. 14B) monitors for the subsequent transmission scheduling information (340b . . . 340n), the user equipment (120) is further caused to stop monitoring for the next subsequent transmission scheduling information (340c . . . 340n) when the subsequent scheduled transmission interval (310b) begins.

(FIG. 17-18, 12A) In one or more embodiments, when a number of slots (i.e., a portion of 312a to 312n) remaining in the subsequent transmission interval (310b) is greater (1970) than a pause threshold number of slots (1220), the user equipment (120) is further caused to pause (1980) the subsequent scheduled transmission interval (310b). In one or more embodiments, the user equipment is further caused to resume (1990) the subsequent scheduled transmission interval (310b) after a retransmission of the first scheduled transmission (420a′) in the next subsequent scheduled transmission interval (310c).

In one or more embodiments, a network node (140) is provided, including at least one processor at least one memory storing instructions that, when executed by the processor, cause the network node (140) to configure (1910), a user equipment (120), with parameters and indicators (1500) that instructs the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the network node (140) is further caused to receive respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

In one or more embodiments, the subsequent scheduling information (340b . . . 340n) (i.e., DCI) is transmitted by the network node (140) to the user equipment (120) during the monitoring period (610) of the tail end portion (330) before the end time (317), to allocate the subsequent scheduled transmission interval (310b . . . 310n) for the subsequent uplink transmission (420b . . . 420n) (PUSCH) by the user equipment (120).

In one or more embodiments, the first scheduling information (340a) configures (1910) the user equipment (120) to (i) remove (1950) the monitoring period (511 or 550) for the subsequent uplink transmission (420b . . . 420n) from the head end portion (320) of the first scheduled transmission interval (310a), and (ii) add (1960) the monitoring period (610) to the tail end portion (330) of the first scheduled transmission interval (310a).

In one or more embodiments, the monitoring period (610) is accommodated to the tail end portion (330) of the first scheduled transmission interval (310a), or the subsequent scheduled transmission interval (310b) by increasing a discontinuous reception retransmission timer (630).

In one or more embodiments, the scheduled transmission interval (310 in FIG. 15) enables the user equipment to perform at least one of (i) transmit during the first scheduled transmission interval (310a) according to one or more physical uplink shared channel (PUSCH) grants (311A to 311D), or (ii) stop processing additional transmission scheduling information (325) that instructs the user equipment (120) to transmit during the first scheduled transmission interval (310a).

In one or more embodiments, the removal of monitoring time (511 or 550—see FIG. 14B) for the subsequent transmitted information (340b . . . 340n) during the head end portion (320) of the first scheduled transmission interval (310a) resulted from one or more priorly scheduled physical uplink shared channel (PUSCH) grants (340a).

In one or more embodiments, at least one of the one or more priorly scheduled physical uplink shared channel (PUSCH) grants (340A to 340D) schedules respective PUSCH repetitions.

In one or more embodiments, the identifying (1930) of the first scheduled transmission interval (310) having the beginning time (315) and the end time (317) comprises the user equipment (120) is configured to be blocked from scheduling new transmissions for at least a percentage of the threshold duration (1010) of the first scheduled transmission interval (310).

In one or more embodiments, at least one of the head end portion (320) or the tail end portion (330) of the first scheduled transmission interval (310) comprises a predetermined number of slots (312a . . . 312n).

In one or more embodiments, the network node (140) is further caused to transmit to the user equipment (120), new transmission scheduling information (340b in FIG. 14B) during the tail end portion (330) of the first scheduled transmission interval (310a). In one or more embodiments, the network node (140) is further caused to, in response to receiving the subsequent transmission scheduling information (340b), stop monitoring for a next subsequent transmission scheduling information (340c) during at least one of (i) (1410) a remainder of the tail end portion (610/330) of the first scheduled transmission interval (310a), or (ii) the head end portion (320) of the subsequent scheduled transmission interval (310b).

In one or more embodiments, the network node (140) is further caused to configure (1910) the user equipment (120) with the threshold duration (1010) via radio resource control.

In one or more embodiments, in a situation that transmission is skipped by the user equipment for at least a portion (321) of the head end portion (320), the user equipment (120) is further caused to monitor for the subsequent scheduling information (340b) for a duration of the tail end portion (330) of the first scheduled transmission interval (310a) as updated to reflect the transmission has been skipped for at least the portion (321) of the head end portion (320) by the user equipment (120).

In one or more embodiments, when the network node (140) monitors for the subsequent transmission scheduling information (340b . . . 340n), the network node (140) is further caused to configure (1910) the user equipment (120) to stop monitoring for the next subsequent transmission scheduling information (340c . . . 340n) when the subsequent scheduled transmission interval (310b) begins.

In one or more embodiments, the network node (140) is further caused configure (1910) the user equipment (120) to, when a number of slots (i.e., a portion of 312a to 312n) remaining in the subsequent scheduled transmission interval (310b) is greater (1970) than a pause threshold number of slots (1220), pause (1980) the subsequent scheduled transmission interval (310b). In one or more embodiments, the network node (140) is further caused to configure (1910) the user equipment (120) to resume (1990) the subsequent scheduled transmission interval (310b) after a retransmission of the first scheduled transmission (420a′) in the next subsequent scheduled transmission interval (310c).

In one or more embodiments, a computer-implemented method is provided that is performed by a user equipment (120) and includes identifying (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the computer-implemented method further includes transmitting respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, the computer-implemented method further includes monitoring (1960) the subsequent scheduling information (340b . . . 340n) during the tail end portion (330) of a first scheduled transmission interval (310a).

In one or more embodiments, the subsequent scheduling information (340b . . . 340n) (i.e., DCI) is transmitted by the network node (140) to the user equipment (120) during the monitoring period (610) of the tail end portion (330) before the end time (317), to allocate the subsequent scheduled transmission interval (310b . . . 310n) for the subsequent uplink transmission (420b . . . 420n) (PUSCH) by the user equipment (120).

In one or more embodiments, the computer-implemented method further includes removing (1950) the monitoring period (511 or 550 or 513) for the subsequent uplink transmission (420b . . . 420n) from the head end portion (320) of a first scheduled transmission interval (310a). In one or more embodiments, the computer-implemented method further includes adding (1960) the monitoring period (610) to the tail end portion (330) of the first scheduled transmission interval (310a).

In one or more embodiments, the monitoring period (610) is accommodated to the tail end portion (330) of the first scheduled transmission interval (310a), or the subsequent scheduled transmission interval (310b) by increasing a discontinuous reception retransmission timer (630).

In one or more embodiments, the computer-implemented method further includes at least one of at least one of (i) transmitting during the first scheduled transmission interval (310a) according to one or more physical uplink shared channel (PUSCH) grants (311A to 311D), or (ii) stopping processing additional transmission scheduling information (325) that instructs the user equipment (120) to transmit during the first scheduled transmission interval (310a).

In one or more embodiments, the removal of monitoring time (511 or 550—see FIG. 14B) for the subsequent transmitted information (340b . . . 340n) during the head end portion (320) of the first scheduled transmission interval (310a) resulted from one or more priorly scheduled physical uplink shared channel (PUSCH) grants (340a).

In one or more embodiments, at least one of the one or more priorly scheduled physical uplink shared channel (PUSCH) grants (340a . . . 340n) schedules respective PUSCH repetitions.

(FIG. 15) In one or more embodiments, the identifying (1930) of the first scheduled transmission interval (310) having the beginning time (315) and the end time (317) comprises the user equipment (120) is configured to be blocked (325) from scheduling new transmissions for at least a percentage of the threshold duration (1010) of the first scheduled transmission interval (310).

(See FIG. 11 element 1010 and 312a . . . 312n, (or FIG. 12, 13, 14)) In one or more embodiments, at least one of the head end portion (320) or the tail end portion (330) of the first scheduled transmission interval (310) comprises a predetermined number (1010) of slots (312a . . . 312n).

(See FIG. 14B) In one or more embodiments, the computer-implemented method further includes receiving new transmission scheduling information (340b in FIG. 14B) during the tail end portion (330) of the first scheduled transmission interval (310a). In one or more embodiments, the computer-implemented method further includes, in response to receiving the subsequent transmission scheduling information (340b), stopping monitoring for a next subsequent transmission scheduling information (340c) during at least one of: (i) (1410) a remainder of the tail end portion (610/330) of the first scheduled transmission interval (310a), or (ii) the head end portion (320) of the subsequent scheduled transmission interval (310b).

(See FIG. 4B) In one or more embodiments, the computer-implemented method further includes receiving (1910) the threshold duration (1010) from the network node (140).

In one or more embodiments, the threshold duration (1010) is received (1910) via radio resource control.

(See FIG. 14B/321) In one or more embodiments, in a situation that transmission is skipped by the user equipment for at least a portion (321) of the head end portion (320), the computer-implemented method further includes monitoring for the subsequent scheduling information (340b) for a duration of the tail end portion (330) of the first scheduled transmission interval (310a) as updated to reflect the transmission has been skipped for at least the portion (321) of the head end portion (320) by the user equipment (120).

In one or more embodiments, when the user equipment (120-FIG. 14B) monitors for the subsequent transmission scheduling information (340b . . . 340n), the computer-implemented method further includes stopping monitoring for the next subsequent transmission scheduling information (340c . . . 340n) when the subsequent scheduled transmission interval (310b) begins.

(FIG. 17-18, 12A) In one or more embodiments, when a number of slots (i.e., a portion of 312a to 312n) remaining in the subsequent transmission interval (310b) is greater (1970) than a pause threshold number of slots (1220), the computer-implemented method further includes pausing (1980) the subsequent scheduled transmission interval (310b). In one or more embodiments, the user equipment is further caused to resume (1990) the subsequent scheduled transmission interval (310b) after a retransmission of the first scheduled transmission (420a′) in the next subsequent scheduled transmission interval (310c).

In one or more embodiments, a computer-implemented method is provided that is performed by a network node (140) and includes configuring (1910), a user equipment (120), with parameters and indicators (1500) that instruct the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the computer-implemented method further includes receiving respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

In one or more embodiments, the subsequent scheduling information (340b . . . 340n) (i.e., DCI) is transmitted by the network node (140) to the user equipment (120) during the monitoring period (610) of the tail end portion (330) before the end time (317), to allocate the subsequent scheduled transmission interval (310b . . . 310n) for the subsequent uplink transmission (420b . . . 420n) (PUSCH) by the user equipment (120).

In one or more embodiments, the first scheduling information (340a) configures (1910) the user equipment (120) to (i) remove (1950) the monitoring period (511 or 550) for the subsequent uplink transmission (420b . . . 420n) from the head end portion (320) of the first scheduled transmission interval (310a), and (ii) add (1960) the monitoring period (610) to the tail end portion (330) of the first scheduled transmission interval (310a).

In one or more embodiments, the monitoring period (610) is accommodated to the tail end portion (330) of the first scheduled transmission interval (310a), or the subsequent scheduled transmission interval (310b) by increasing a discontinuous reception retransmission timer (630).

In one or more embodiments, the scheduled transmission interval (310 in FIG. 15) enables the user equipment to perform at least one of (i) transmitting during the first scheduled transmission interval (310a) according to one or more physical uplink shared channel (PUSCH) grants (311A to 311D), or (ii) stopping processing additional transmission scheduling information (325) that instructs the user equipment (120) to transmit during the first scheduled transmission interval (310a).

In one or more embodiments, the removal of monitoring time (511 or 550—see FIG. 14B) for the subsequent transmitted information (340b . . . 340n) during the head end portion (320) of the first scheduled transmission interval (310a) resulted from one or more priorly scheduled physical uplink shared channel (PUSCH) grants (340a).

In one or more embodiments, at least one of the one or more priorly scheduled physical uplink shared channel (PUSCH) grants (340A to 340D) schedules respective PUSCH repetitions.

In one or more embodiments, the identifying (1930) of the first scheduled transmission interval (310) having the beginning time (315) and the end time (317) comprises the user equipment (120) is configured to be blocked from scheduling new transmissions for at least a percentage of the threshold duration (1010) of the first scheduled transmission interval (310).

In one or more embodiments, at least one of the head end portion (320) or the tail end portion (330) of the first scheduled transmission interval (310) comprises a predetermined number of slots (312a . . . 312n).

In one or more embodiments, the computer-implemented method further includes transmitting to the user equipment (120), new transmission scheduling information (340b in FIG. 14B) during the tail end portion (330) of the first scheduled transmission interval (310a). In one or more embodiments, the computer-implemented method further includes, in response to receiving the subsequent transmission scheduling information (340b), stopping monitoring for a next subsequent transmission scheduling information (340c) during at least one of (i) (1410) a remainder of the tail end portion (610/330) of the first scheduled transmission interval (310a), or (ii) the head end portion (320) of the subsequent scheduled transmission interval (310b).

In one or more embodiments, the computer-implemented method further includes configuring (1910) the user equipment (120) with the threshold duration (1010) via radio resource control.

In one or more embodiments, in a situation that transmission is skipped by the user equipment for at least a portion (321) of the head end portion (320), the user equipment (120) is further caused to monitor for the subsequent scheduling information (340b) for a duration of the tail end portion (330) of the first scheduled transmission interval (310a) as updated to reflect the transmission has been skipped for at least the portion (321) of the head end portion (320) by the user equipment (120).

In one or more embodiments, when the network node (140) monitors for the subsequent transmission scheduling information (340b . . . 340n), the computer-implemented method further includes configuring (1910) the user equipment (120) to stop monitoring for the next subsequent transmission scheduling information (340c . . . 340n) when the subsequent scheduled transmission interval (310b) begins.

In one or more embodiments, the computer-implemented method further includes configuring (1910) the user equipment (120) to, when a number of slots (i.e., a portion of 312a to 312n) remaining in the subsequent scheduled transmission interval (310b) is greater (1970) than a pause threshold number of slots (1220), pause (1980) the subsequent scheduled transmission interval (310b). In one or more embodiments, the computer-implemented method further includes configuring (1910) the user equipment (120) to resume (1990) the subsequent scheduled transmission interval (310b) after a retransmission of the first scheduled transmission (420a′) in the next subsequent scheduled transmission interval (310c).

In one or more embodiments, a non-transitory computer readable storage medium is provided including computer instructions that, when executed by a user equipment (120), cause the user equipment (120) to identify (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the user equipment (120) is further caused to transmit respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, a non-transitory computer readable storage medium is provided including computer instructions that, when executed by a network node (140), cause the network node (140) to configure (1910), a user equipment (120), with parameters and indicators (1500) that instruct the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the network node (140) is further caused to receive respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

In one or more embodiments, a user equipment (120) is provided including means for identifying (1930) one or more scheduled transmission intervals (310a . . . 310n) having a beginning time (315) and an end time (317), based on initial scheduling information (340a) received from a network node (140), where the one or more scheduled transmission intervals (310a . . . 310n) is longer than a threshold duration (1010) for one or more uplink transmissions (420a . . . 420n) by the user equipment (120) according to initial scheduling information (340a), where the one or more scheduled transmission intervals (310a . . . 310n) includes a head end portion (320) and a tail end portion (330), and the tail end portion (330) accommodates a monitoring period (610). In one or more embodiments, the user equipment (120) further includes means for transmitting respectively (1920), to a network node (140), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610a . . . 610n) before the end time (317).

In one or more embodiments, a network node (140) is provided that includes means for configuring (1910), a user equipment (120), with parameters and indicators (1500) that instruct the user equipment (120) to identify one or more scheduled transmission intervals (310a . . . 310n) having a beginning time (315) and an end time (317), based on initial scheduling information (340a) to a first scheduled transmission interval (310a) received from a network node (140), where the one or more scheduled transmission intervals (310a . . . 310n) is longer than a threshold duration (1010) for one or more uplink transmissions (420a . . . 420n) by the user equipment (120) according to the initial scheduling information (340a), wherein the one or more scheduled transmission intervals (310a . . . 310n) includes a head end portion (320) and a tail end portion (330), and the tail end portion (330) accommodates a monitoring period (610). In one or more embodiments, the network node (140) further includes means for receiving respectively (1920), from the user equipment (120), at least one subsequent uplink transmission (420b . . . 420n) (i.e., PUSCH) corresponding to a respective subsequent scheduled transmission interval (310b . . . 310n), according to subsequent scheduling information (340b . . . 340n) received from the network node (140), within the monitoring period (610) before the end time (317).

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

### LEGEND

| | |
|---|---|
| 120 | user equipment |
| 140 | network node |
| 310a | first scheduled transmission interval |
| 310b . . . 310n | subsequent scheduled transmission interval |
| 310b_1 | first portion of subsequent scheduled transmission interval transmitted prior to |
| | pausing for retransmission of first scheduled transmission interval |
| 310b_2 | subsequent portion of subsequent scheduled transmission interval transmitted |
| | after pausing for retransmission of first scheduled transmission interval |
| 310c | next subsequent scheduled transmission interval |
| 311A . . . 311D | PUSCH transmissions (resulting from configured grants) |
| 312a . . . 312n | repetitions |
| 315 | beginning time |
| 317 | end time |
| 320 | head end portion |
| 321 | skipped portion (detected) |
| 320 | head end portion |
| 330 | tail end portion |
| 340a | initial scheduling information |
| 340b . . . 340n | subsequent scheduling information |
| 410 | physical downlink control channel monitoring occasion |
| 420a | initial uplink transmission |
| 420a′ | retransmission of initial uplink transmission |
| 420b . . . 420n | subsequent uplink transmission |
| 510 | monitoring period |
| 512 | monitoring period not resulting from prior UL grants/transmissions (e.g. only due |
| | to OnDuration) |
| 513 | monitoring period occurring after 550 |
| | where 550 was for scheduling a retransmission, |
| | And 513 is used in FIG. 17 to show active time moved after the |
| | retransmission is scheduled causing the pause function. |
| 520 | scheduled time period where monitoring time may be inefficient |
| 530 | scheduled time period where monitoring time may be (relatively) efficient |
| 511, 550 | monitoring period resulting from prior UL grants/transmissions (e.g. only due to |
| | Inactivity Timer and Retransmission Timer Respectively and not due to OnDuration). |
| 610 | monitoring period |
| 630 | discontinuous reception retransmission timer (DRX) drx-HARQ-RTT-TimerUL |
| | timer |
| 810 | time interval where network node is in a state of discontinuous transmission |
| 820 | time interval where network node resumes transmission |
| 1010 | threshold duration |
| 1020 | (Ad Hoc) Monitoring time duration, e.g. the length of 610 in some embodiments |
| | (where monitoring time length is not reduced after receiving DCI scheduling the UE to |
| | transmit during a next/subsequent interval) |
| 1030 | Tail offset time 1030 (FIG. 10), i.e. the starting time of 610 |
| 1210 | pause resume operation |
| 1220 | remainder threshold |
| 1410 | remainder portion of monitoring period |
| 1500 | parameters and indicators from network that instruct the user equipment to |
| | identify one or more scheduled transmission intervals according to the invention |
| 1501 | Configured (and dynamic) Grants Signaled to UE |

What is claimed is:

1. A user equipment, comprising:
at least one processor; and
at least one memory storing instruction that, when executed by the processor, cause the user equipment to:
identify one or more scheduled transmission intervals having a beginning time and an end time, based on initial scheduling information received from a network node, wherein the one or more scheduled transmission intervals is longer than a threshold duration for one or more uplink transmissions by the user equipment according to initial scheduling information, wherein the one or more scheduled transmission intervals comprises a head end portion and a tail end portion, and the tail end portion accommodates a monitoring period; and
transmit respectively, to a network node, at least one subsequent uplink transmission corresponding to a respective subsequent scheduled transmission interval, according to subsequent scheduling information received from the network node, within the monitoring period before the end time.

2. The user equipment of claim 1, is further caused to perform at least one of:
(a) monitor the subsequent scheduling information during the tail end portion of a first scheduled transmission interval;
(b) receive the threshold duration from the network node;
(c) remove the monitoring period for the subsequent uplink transmission from the head end portion of a first scheduled transmission interval, and add the monitoring period to the tail end portion of the first scheduled transmission interval;
(d) receive new transmission scheduling information during the tail end portion of the first scheduled transmission interval; and in response to receiving the subsequent transmission scheduling information, stop monitoring for a next subsequent transmission scheduling information during at least one of:
a remainder of the tail end portion of the first scheduled transmission interval; or
the head end portion of the subsequent scheduled transmission interval;
(e) receiving the threshold duration via radio resource control; or
(f) when a number of slots remaining in the subsequent transmission interval is greater than a pause threshold number of slots, pause the subsequent scheduled transmission interval; and resume the subsequent scheduled transmission interval after a retransmission of the first scheduled transmission in the next subsequent scheduled transmission interval.

3. The user equipment of claim 1, wherein the subsequent scheduling information is transmitted by the network node to the user equipment during the monitoring period of the tail end portion before the end time, to allocate the subsequent scheduled transmission interval for the subsequent uplink transmission by the user equipment.

4. The user equipment of claim 1, wherein the monitoring period is accommodated to the tail end portion of the first scheduled transmission interval, or the subsequent scheduled transmission interval by increasing a discontinuous reception retransmission timer.

5. The user equipment of claim 1, wherein the scheduled transmission interval enables the user equipment to perform at least one of:
transmit during the first scheduled transmission interval according to one or more physical uplink shared channel (PUSCH) grants; or
stop processing additional transmission scheduling information that instructs the user equipment to transmit during the first scheduled transmission interval.

6. The user equipment of claim 1, wherein the removal of monitoring time for the subsequent transmitted information during the head end portion of the first scheduled transmission interval resulted from one or more priorly scheduled physical uplink shared channel (PUSCH) grants.

7. The user equipment of claim 6, wherein at least one of the one or more priorly scheduled physical uplink shared channel (PUSCH) grants schedules respective PUSCH repetitions.

8. The user equipment of claim 1, wherein the identifying of the first scheduled transmission interval having the beginning time and the end time comprises the user equipment is configured to be blocked from scheduling new transmissions for at least a percentage of the threshold duration of the first scheduled transmission interval.

9. The user equipment of claim 1, wherein at least one of the head end portion or the tail end portion of the first scheduled transmission interval comprises a predetermined number.

10. The user equipment of claim 1, wherein in a situation that transmission is skipped by the user equipment for at least a portion of the head end portion, the user equipment is further caused to:
monitor for the subsequent scheduling information for a duration of the tail end portion of the first scheduled transmission interval as updated to reflect the transmission has been skipped for at least the portion of the head end portion by the user equipment.

11. The user equipment of claim 1, wherein when the user equipment monitors for the subsequent transmission scheduling information, the user equipment is further caused to:
stop monitoring for the next subsequent transmission scheduling information when the subsequent scheduled transmission interval begins.

12. A network node, comprising:
at least one processor; and
at least one memory storing instructions that, when executed by the processor, cause the network node to:
configure, a user equipment, with parameters and indicators that instruct the user equipment to identify one or more scheduled transmission intervals having a beginning time and an end time, based on initial scheduling information to a first scheduled transmission interval received from a network node, wherein the one or more scheduled transmission intervals is longer than a threshold duration for one or more uplink transmissions by the user equipment according to the initial scheduling information, wherein the one or more scheduled transmission intervals comprises a head end portion and a tail end portion, and the tail end portion accommodates a monitoring period; and
receive respectively, from the user equipment, at least one subsequent uplink transmission corresponding to a respective subsequent scheduled transmission interval, according to subsequent scheduling information received from the network node, within the monitoring period before the end time.

13. The network node of claim 12, wherein the subsequent scheduling information is transmitted by the network node to the user equipment during the monitoring period of the tail end portion before the end time, to allocate the subsequent scheduled transmission interval for the subsequent uplink transmission by the user equipment.

14. The network node of claim 12, wherein the first scheduling information configures the user equipment to:
remove the monitoring period for the subsequent uplink transmission from the head end portion of the first scheduled transmission interval; and
add the monitoring period to the tail end portion of the first scheduled transmission interval.

15. The network node of claim 14, wherein the removal of monitoring time for the subsequent transmitted information during the head end portion of the first scheduled transmission interval resulted from one or more priorly scheduled physical uplink shared channel (PUSCH) grants.

16. The network node of claim 13, wherein the identifying of the first scheduled transmission interval having the beginning time and the end time comprises the user equipment is configured to be blocked from scheduling new transmissions for at least a percentage of the threshold duration of the first scheduled transmission interval.

17. The network node of claim 13, wherein at least one of the head end portion or the tail end portion of the first scheduled transmission interval comprises a predetermined number of slots.

18. The network node of claim 12, further caused to perform at least one of:
(a) transmit to the user equipment, new transmission scheduling information during the tail end portion of the first scheduled transmission interval; and
in response to receiving the subsequent transmission scheduling information, stop monitoring for a next subsequent transmission scheduling information during at least one of:
a remainder of the tail end portion of the first scheduled transmission interval; or
the head end portion of the subsequent scheduled transmission interval;
(b) configure the user equipment with the threshold duration via radio resource control; or
(c) configure the user equipment to:
when a number of slots remaining in the subsequent scheduled transmission interval is greater than a pause threshold number of slots, pause the subsequent scheduled transmission interval; and
resume the subsequent scheduled transmission interval after a retransmission of the first scheduled transmission in the next subsequent scheduled transmission interval.

19. The network node of claim 13, wherein in a situation that transmission is skipped by the user equipment for at least a portion of the head end portion, the user equipment is further caused to:
monitor for the subsequent scheduling information for a duration of the tail end portion of the first scheduled transmission interval as updated to reflect the transmission has been skipped for at least the portion of the head end portion by the user equipment.

20. The network node of claim 13, wherein when the network node monitors for the subsequent transmission scheduling information, the network node is further caused to:
configure the user equipment to stop monitoring for the next subsequent transmission scheduling information when the subsequent scheduled transmission interval begins.
